(19) United States
(12) Patent Application Publication
(10) Pub. No.: US 2013/0152110 A1
(43) Pub. Date: Jun. 13, 2013

(54) OPTICAL DRIVE SYSTEM, CARTRIDGE AND DRIVE DEVICE WHICH ARE USED IN OPTICAL DRIVE SYSTEM, AND CLEANING METHOD FOR OPTICAL DRIVE SYSTEM

(71) Applicants: Hideki Nakata, Kyoto (JP); Kousei Sano, Osaka (JP)

(72) Inventors: Hideki Nakata, Kyoto (JP); Kousei Sano, Osaka (JP)

(21) Appl. No.: 13/817,020

(22) PCT Filed: Jun. 15, 2012
(86) PCT No.: PCT/JP2012/003924

§ 371 Date: Feb. 14, 2013

(30) Foreign Application Priority Data
Jun. 16, 2011 (JP) 2011-133975

(51) Int. Cl. G11B 33/14

(52) U.S. Cl. CPC G11B 33/146
USPC 720/648

(57) ABSTRACT

The present application discloses an optical drive system, including: a cartridge with a wall portion which defines a storage room to store a rotatable record medium with a light receiving surface scanned by light; and a drive device with a rotary driver, which rotates the record medium, an optical element, which irradiates the light, and a movement driver, which moves the optical element between inner and outer positions. The wall portion is provided with an outlet at the outer position. Air in the storage room is exhausted from the outlet by air flow resulting from rotation of the record medium. The outlet is divided into first and second opening regions by a movement track of the optical element. The first opening region is larger than the second opening region at an upstream position of the first opening region in a rotational direction of the record medium.

### TECHNICAL FIELD

The present invention relates to an optical drive system configured to optically process information, a cartridge configured to store a record medium which stores the information to be optically processed, a drive device configured to drive the record medium in the cartridge, and a method for cleaning the optical drive system.

### BACKGROUND ART

Technologies to optically process information largely contribute to an increase in a capacity of storage media. Technologies to record or reproduce information on or from a record medium by means of near-field light have been developed as the optical processing technologies. A record medium which stores information at high density may be utilized under usage of near-field light for these information processes.

A solid immersion lens (SIL) (hereafter called “SIL”) may be exemplified as an optical system to generate near-field light for recording and/or reproducing information. The SIL may be used as an object lens.

In order to read and/or reproduce information by means of near-field light, technologies to make an SIL approach a record medium have been developed. According to this approach technologies, the SIL approaches a record medium so that a distance between the SIL and the record medium becomes no more than ½ of a wavelength of utilized light (e.g. approximately 1/10 of utilized light). The aforementioned optical system generating near-field light between the SIL and the record medium enables high density recording and/or reproducing (e.g. 1 or greater numerical aperture (NA)).

The technologies to record and/or reproduce information by means of near-field light may be applied to an optical drive system. The optical drive system may have a record medium and an object lens portion. The object lens portion may include a collective element and other optical elements. For example, the aforementioned SIL may be installed on a collective element.

A gap between an end surface of the SIL (hereafter called “SIL end surface”) on the collective element and the record medium has to be set to a distance which is short enough to generate near-field light (near field). If a laser beam having a short wavelength is used for recording and/or reproducing information, the optical drive system has to be controlled so that the gap between the SIL end surface and the record medium is approximately several tens nm.

Patent Document 1 discloses optical control technologies to control a distance between an SIL and a surface of a record medium by means of a biaxial electromagnetic actuator. According to the technologies disclosed in Patent Document 1, a disk substrate is used as the record medium. In order to appropriately control the distance between the SIL and a surface of the disk substrate on the basis of the technologies disclosed in Patent Document 1, the surface of the disk substrate has to have a high level flatness. In addition, vibratory factors such as resonance resulting from rotation of the disk have to be sufficiently reduced.

Dust floating in the optical drive system may interrupt recording and/or reproducing information. Dust may become critical if an optical drive system uses near-field light. For example, dust adhering to an SIL end surface may not be negligible for the gap control between the record medium and the SIL end surface.

Airborne dust and fibers of clothes may be exemplified as the dust adhering to the SIL end surface. Dust particles are often larger in width and/or height than a target value of the gap between the record medium and the SIL end surface. Therefore, a large dust particle adhering to the SIL end surface may disable the aforementioned gap control.

Dust may be removed to some extent during manufacture of an optical head configured to optically process information for a record medium, a drive device or an optical drive system in which the optical head is integrated. However, it is difficult to completely remove dust.

Dust may also adhere during use of the aforementioned devices after the manufacturing processes. In order to prevent the in-use dust adhesion, it may be effective to integrate a disk used as a record medium with a drive device configured to drive the disk for a completely sealed structure design, like hard disk drives. However, removability is demanded for a record medium (optical disk) from an optical drive system. Therefore, it is not desirable to seal and secure the record medium in the optical drive system.

An optical drive system often includes a cartridge to store a record medium. The cartridge may make dust less influential to some extent. However, dust may enter through openings formed on the cartridge. Accordingly, it is very difficult to completely remove dust from a space to store the record medium.

Patent Document 2 discloses a media cleaning mechanism configured to remove dust on a record medium. The media cleaning mechanism uses a cleaning tape to directly wipe off dust adhering to a surface of a record medium.

Dust removal on a record medium makes dust less influential. However, dust adhering to an SIL end surface greatly interrupts the aforementioned gap control (c.f. Patent Document 1).

In addition to the media cleaning mechanism, Patent Document 2 also discloses a lens cleaning mechanism. The lens cleaning mechanism contacts a cleaning tape on an SIL to remove dust adhering to an SIL end surface, which results in appropriate gap control.

FIG. 42 is a schematic view showing the drive device 900 which is used for a conventional optical drive system. The drive device 900 is described with reference to FIG. 42.

The drive device 900 includes an optical head 910, a servo control system 920 and a spindle motor 930. The optical head 910 and the spindle motor 930 operate under control of the servo control system 920. The spindle motor 930 rotates an optical disk 950 which is used as a record medium.

The optical head 910 includes a laser diode 911 (in FIG. 42, “LD” denotes the laser diode), two collimator lenses 912, 913, an anamorphic prism 914 configured to shape a laser beam emitted from the collimator lens 912, a beam splitter 915 (in FIG. 42, “BS” denotes the beam splitter), a quarter wave plate 916 (in FIG. 42, “QWP” denotes the quarter wave plate), a corrective lens 917 configured to correct chromatic aberration, an extender lens 918 configured to extend the laser beam, a Wollaston prism 919, two collective lenses 941, 942, a collective element 943, two photo-detectors 944, 945 (in FIG. 42, “PD” denotes the photo-detector), an auto power controller 946 (in FIG. 42, “APC” denotes the auto power controller) and an LD driver 947.

The Wollaston prism 919 is constituted by two prisms. Light entering the Wollaston prism 919 is emitted as two linearly polarized light beams which intersect orthogonally. Various signals such as RF reproduction signals, which are used for reproducing signals recorded on the optical disk 950, tracking error signals and gap error signals, which are required for servo control, are output from the photo-detector 944 to the servo control system 920.

The servo control system 920 includes a gap servo module 921 (focusing servo module), a tracking servo module 922, a tilt servo module 923 and a spindle servo module 924. The tracking servo module 922 executes tracking control for the collective element 943 in response to the tracking error signals. The tilt servo module 923 controls a tilt angle of the collective element 943. The spindle servo module 924 controls rotation of the spindle motor 930. The gap servo module 921 is described later.

The auto power controller 946 outputs predetermined signals to the LD driver 947 in response to the signals output from the photo-detector 945. The LD driver 947 makes power of the laser emitted from the laser diode 911 constant in response to the signals from the auto power controller 946.

Operation of the aforementioned optical system of the drive device 900 is described with reference to FIG. 42.

As shown in FIG. 42, the optical disk 950 used as a record medium is set in the drive device 900. Then, the servo control system 920 uses the gap servo module 921, the tracking servo module 922, the tilt servo module 923 and the spindle servo module 924 to perform various servo controls.

The laser diode 911 emits a laser beam toward the collimator lens 912. The collimator lens 912 collimates the laser beam. Then, the anamorphic prism 914 shapes the collimated light.

The shaped laser beam enters the beam splitter 915. The beam splitter 915 splits the entered laser beam into one light beam entering the quarter wave plate 916 and another light beam entering the collective lens 942. The laser beam entering the collective lens 942 is used for the auto power controller 946, as described above. The auto power controller 946 outputs signals to the LD driver 947 in response to the received laser beam, so that the laser diode 911 may emit a laser beam having a predetermined power.

The quarter wave plate 916 transforms the entered laser beam from linearly polarized light into circularly polarized light. Then, the correction lens 917 corrects chromatic aberration. The laser beam transmits through the extender lens 918 and the collimator lens 913 after the correction lens 917, and then enters the collective element 943.

The collective element 943 concentrates the entered laser beam toward the optical disk 950 so as to generate near-field light. Consequently, signals are recorded on the optical disk 950. It is described later how to generate near-field light by means of the collective element 943.

The near-field light generated by the condensing operation toward the optical disk 950 may be used for reading signals recorded on the optical disk 950. The near-field light enters the optical disk 950. The optical disk 950 reflects or diffracts the near-field light to generate reflected light or diffracted light (hereafter called “return light”). The collective element 943 receives the return light. After the collective element 943, the return light transmits through the collimator lens 913, the extender lens 918, the correcting lens 917 and the quarter wave plate 916, and then enters the beam splitter 915. The beam splitter 915 fully reflects the return light toward the Wollaston prism 919. Then, the return light transmits through the Wollaston prism 919 and the collective lens 941, and then enters the photo-detector 944. The photo-detector 944 generates RF reproduction signals and servo control signals in response to the entered return light. The servo control signals are output from the photo-detector 944 to the servo control system 920. The servo control system 920 uses the gap servo module 921, the tracking servo module 922, the tilt servo module 923 and the spindle servo module 924 to perform various servo controls.

FIG. 43 is an enlarged schematic view of the collective element 943 situated near the optical disk 950. The collective element 943 is described with reference to FIGS. 42 and 43.

The collective element 943 faces the optical disk 950. The collective element 943 includes an SIL 961 and an aspherical lens 962. The SIL 961 and the aspherical lens 962 generate near-field light.

The collective element 943 further includes a lens holder 963. The lens holder 963 holds the SIL 961 and the aspherical lens 962.

The SIL 961 includes an SIL end surface 964 which faces the optical disk 950. The optical disk 950 includes a record surface 951 which faces the SIL end surface 964. The near-field light is irradiated from the SIL end surface 964 onto the record surface 951.

The drive device 900 further includes a tri-axial actuator 965 mounted on the lens holder 963. The tri-axial actuator 965 is used as a part of a separation mechanism configured to move the collective element 943 apart from the record surface 951.

The tri-axial actuator 965 is very simplified in FIGS. 42 and 43. The tri-axial actuator 965 is constituted by coils or yokes in three axis directions. The servo control system 920 applies a predetermined servo voltage to each coil of the tri-axial actuator 965. Consequently, predetermined current flows into each coil of the tri-axial actuator 965 to execute the focusing servo control, which includes the tracking servo and gap servo, and tilt servo control.

FIG. 44 is an enlarged schematic view of the drive device 900 around the optical disk 950. FIG. 45 is a schematic bottom view of the drive device 900 corresponding to FIG. 44. The drive device 900 is further described with reference to FIGS. 44 and 45.

The drive device 900 includes a lens cleaning mechanism 970 configured to clean the SIL 961, and a disk cleaning mechanism 980 configured to contact the record surface 951 of the optical disk 950 and clean the record surface 951. The lens cleaning mechanism 970 contacts the SIL end surface 964. The lens cleaning mechanism 970 is more distant from the rotational axis RX of the optical disk 950 than the peripheral edge 952 of the optical disk 950 mounted on the spindle motor 930.

FIGS. 46A to 46C are schematic views of the lens cleaning mechanism 970. The lens cleaning mechanism 970 is described with reference to FIGS. 44 to 46C.

As shown in FIGS. 46A to 46C, the lens cleaning mechanism 970 may be a cleaning device which uses a cleaning tape 971 to clean the SIL 961. The lens cleaning mechanism 970 includes two spindles 972, 973, and two idlers 974, 975 which define a traveling path of the cleaning tape 971. The cleaning tape 971 travels on the SIL 961 as the spindles 972, 973 rotate. The cleaning tape 971 is formed from sufficiently soft resin not to damage the SIL 961.

As shown in FIGS. 44 and 45, the collective element 943 moves toward the lens cleaning mechanism 970 situated outside the optical disk 950. The collective element 943 situated below the lens cleaning mechanism 970 moves vertically. Consequently, as shown in FIGS. 46A to 46C, the SIL end surface 964 separates from the cleaning tape 971. The collective element 943 may be moved vertically by the aforementioned tri-axial actuator 965 (e.g. coil for gap servo). The collective element 943 may be moved vertically by other driving mechanisms (not shown), instead of the servo system. Alternatively the lens cleaning mechanism 970 may be designed so that the lens cleaning mechanism 970 approaches the collective element 943, instead of movement of the collective element 943.

As shown in FIGS. 44 and 45, the disk cleaning mechanism 980 includes a cleaning member 981, which faces the record surface 951 of the optical disk 950, and a support 982 which supports the cleaning member 981. A motor (not shown) moves the support 982 vertically. The cleaning member 981 may be a strip which is substantially as long as a radius of the optical disk 950. The cleaning member 981 is formed from fiber or mesh material. It is more preferable if the cleaning member 981 is formed from lens paper. The cleaning member 981 contacts the record surface 951 to remove dust without scratching the record surface 951.

FIG. 47 is a schematic flow chart of various operations of the drive device 900 before recording and/or reproducing signals (e.g. cleaning operation, initial tilt adjustment operation, gap servo operation). The operation of the drive device 900 is described with reference to FIGS. 42, 44, 46A to 47.

### (Step S905)

The operation of the drive device 900 starts with step S905. In step S905, the collective element 943 moves downward from the lens cleaning mechanism 970 (c.f. FIG. 44). As shown in FIGS. 46A and 46B, the collective element 943 then moves upward. Consequently, the SIL 961 moves from a separation position, at which the SIL 961 is separated from the cleaning tape 971, to a contact position, at which the SIL 961 contacts the tape. As shown in FIG. 46B, after the SIL 961 moves to the contact position, the cleaning tape 971 travels to remove dust adhering to the SIL end surface 964. After the cleaning operation, the collective element 943 moves downward. The collective element 943 then returns to a position at which the collective element 943 faces the record surface 951 of the optical disk 950, and step S905 ends. Then step S906 starts.

### (Step S910)

In step S910, the tilt servo module 923 adjusts a tile angle of the collective element 943. Then step S915 is executed.

### (Step S915)

In step S915, the gap servo module 921 starts gap servo control. Then step S920 is executed.

### (Step S920)

In step S920, the spindle motor 930 rotates the optical disk 950 at low speed. Then step S925 is executed.

### (Step S925)

In step S925, the gap servo module 921 counts a number of gap errors exceeding a predetermined threshold every rotation of the optical disk 950. If the counted value is lower than a predetermined value (N), step S930 is executed. Otherwise step S945 is executed.

### (Step S930)

In step S930, the spindle motor 930 rotates the optical disk 950 at a predetermined rotational speed. Then step S935 is executed.

### (Step S935)

In step S935, the gap servo module 921 determines whether an absolute value of the gap error is lower than a predetermined threshold. If the absolute value of the gap error is lower than the predetermined threshold, step S940 is executed. Otherwise the drive device 900 stops operation.

### (Step S940)

In step S900, the drive device 900 records or reproduces signals on or from the optical disk 950. Then the drive device 900 ends the operation.

### (Step S945)

In step S945, the spindle motor 930 stops rotating the optical disk 950. Then step S950 is executed.

### (Step S950)

In step S950, the disk cleaning mechanism 980 cleans the record surface 951 of the optical disk 950. Then step S955 is executed.

### (Step S955)

In step S955, the collective element 943 moves upward. Consequently, the SIL 961 contacts the record surface 951 of the optical disk 950. Then step S960 is executed.

### (Step S960)

In step S960, the servo control system 920 determines whether an amount of fully-reflected return light from the beam splitter 915 is lower than a predetermined threshold. If the amount of the fully-reflected return light from the beam splitter 915 is lower than the predetermined threshold, step S915 is executed again. Otherwise step S905 is executed again.

In step S905, the cleaning tape 971 directly contacts the SIL end surface 964 to remove dust adhering to the SIL end surface 964. The dust removed by the cleaning tape 971 adheres to the cleaning tape 971. The dust adhering to the cleaning tape 971 may then adhere to the SIL end surface 964 again.

The lens cleaning mechanism 970 shown in FIG. 46A to 46C winds the cleaning tape 971 up. Therefore, the SIL end surface 964 is contacted by a fresh surface of the cleaning tape 971. However, winding the cleaning tape 971 dramatically decreases a number of times to clean the SIL end surface 964. In addition, the cleaning mechanism using the cleaning tape 971 and the tape winding mechanism increase a size of the optical drive system, in which the drive device 900 is integrated.

Patent Document 1: JP 2004-30821 A

Patent Document 2: JP 2007-12126 A

### SUMMARY OF THE INVENTION

The present invention provides technologies to appropriately remove dust.

An optical drive system according to one aspect of the present invention includes: a cartridge including a wall portion configured to define a storage room to store a rotatable record medium including a light receiving surface which is scanned by light for optically processing information; and a drive device including a rotary driver configured to rotate the record medium in the storage room, an optical element configured to irradiate the light onto the light receiving surface, and a movement driver configured to move the optical element between an inner position where the optical element faces the light receiving surface, and an outer position more distant from a rotational axis of the record medium than the inner position. The wall portion is provided with an outlet at the outer position. Air in the storage room is exhausted from the outlet by air flow resulting from rotation of the record medium. The outlet is divided into a first opening region and a second opening region by a movement track of the optical element so that the first opening region has a first size and the second opening region has a second size larger than the first size. The second opening region is situated at an upstream position of the first opening region in a rotational direction of the record medium.

A cartridge according to another aspect of the present invention defines a storage room to store a rotatable record medium including a light receiving surface which is scanned by light for optically processing information. The cartridge includes a wall portion provided with an outlet apart from a rotational axis of the record medium, so that air in the cartridge is exhausted from the outlet by air flow resulting from rotation of the record medium. The outlet is divided into a first opening region and a second opening region by a scanning track of the light so that the first opening region has a first size and the second opening region has a second size larger than the first size. The second opening region is situated at an upstream position of the first opening region in a rotational direction of the record medium.

A drive device according to another aspect of the present invention includes: a rotary driver configured to rotate a record medium including a light receiving surface which is scanned by light for optically processing information; an optical element configured to irradiate the light onto the light receiving surface; a movement driver configured to move the optical element between an inner position where the optical element faces the light receiving surface and an outer position more distant from a rotational axis of the record medium than the inner position; a holder configured to hold the optical element; and an actuator configured to drive the holder in a focusing direction and a tracking direction of the record medium with elastically supporting the holder. The actuator makes the optical element approach a plane which extends along the light receiving surface at the outer position.

A method for cleaning the optical drive system according to another aspect of the present invention includes steps of: rotating the record medium; moving the optical element from the inner position to the outer position; and making the optical element approach a plane which extends along the light receiving surface, so as to expose the optical element to air flow resulting from rotation of the record medium.

A method for cleaning the optical drive system according to another aspect of the present invention includes steps of: moving the first shutter to the close position; and rotating the record medium.

The present invention may appropriately remove dust.

Objectives, features and advantages of the present invention will become more apparent upon reading the following detailed description along with the accompanying drawings.

### BRIEF DESCRIPTION OF THE DRAWINGS

FIG. 1 is a schematic view of an exemplary optical head integrated into an optical drive system.

FIG. 2 is a schematic view of a hologram element of the optical head shown in FIG. 1.

FIG. 3 is a schematic view of a photo-detector of the optical head shown in FIG. 1.

FIG. 4 is a schematic view of a cylindrical lens of the optical head shown in FIG. 1.

FIG. 5 is a schematic view of a quadrant light receiving area of the photo-detector shown in FIG. 3.

FIG. 6 is a schematic view of an optical drive system according to the first embodiment.

FIG. 7 is a schematic graph showing an amount of fully-reflected return light with respect to a gap.

FIG. 8A is a schematic plan view of a cartridge of the optical drive system shown in FIG. 6.

FIG. 8B is a schematic bottom view of the cartridge shown in FIG. 8A.

FIG. 9 is an enlarged schematic cross-sectional view of the optical drive system around the cartridge shown in FIG. 8A.

FIG. 10A is a schematic plan view of the cartridge shown in FIG. 8A.

FIG. 10B is a schematic bottom view of the cartridge shown in FIG. 8B.

FIG. 11 is an enlarged schematic cross-sectional view of the optical drive system around the cartridge shown in FIG. 8A.

FIG. 12 is a schematic cross-sectional view of the cartridge along the A-A line in FIG. 10A.

FIG. 13 is a photo showing exemplary computing results about flow velocity of air blown from an opening at an outer position.

FIG. 14 is a schematic view of an optical drive system according to the second embodiment.

FIG. 15 is a schematic plan view of a cartridge of the optical drive system shown in FIG. 14.

FIG. 16 is a schematic cross-sectional view of the cartridge along the A-A line in FIG. 15.

FIG. 17 is a schematic flow chart of a method for cleaning an SIL end surface of the optical drive system shown in FIG. 14.

FIG. 18 is a schematic view of an optical drive system according to the third embodiment.

FIG. 19 is a schematic view of an optical head of the optical drive system shown in FIG. 18.

FIG. 20 is a schematic plan view of a cartridge of the optical drive system shown in FIG. 18.

FIG. 21 is a schematic view of an optical drive system according to the fourth embodiment.

FIG. 22A is a schematic plan view of a cartridge of the optical drive system shown in FIG. 21.

FIG. 22B is a schematic bottom view of the cartridge shown in FIG. 22A.

FIG. 23 is an enlarged schematic cross-sectional view of the optical drive system around the cartridge shown in FIG. 22A.

FIG. 24 is a schematic view of an optical drive system according to the fifth embodiment.

FIG. 25A is a schematic plan view of a cartridge of the optical drive system shown in FIG. 24.

FIG. 25B is a schematic bottom view of the cartridge shown in FIG. 25A.

FIG. 26 is an enlarged schematic cross-sectional view of the optical drive system around the cartridge shown in FIG. 25A.

FIG. 27 is a schematic view of an optical drive system according to the sixth embodiment.

FIG. 28A is a schematic plan view of a cartridge of the optical drive system shown in FIG. 27.

FIG. 28B is a schematic bottom view of the cartridge shown in FIG. 28A.

FIG. 29 is an enlarged schematic cross-sectional view of the optical drive system around the cartridge shown in FIG. 28A.

FIG. 30 is a schematic view of an optical drive system according to the seventh embodiment.

FIG. 31 is a schematic view of an optical drive system according to the eighth embodiment.

FIG. 32 is a schematic bottom view of a shutter mechanism of the optical drive system shown in FIG. 31.

FIG. 33 is a schematic bottom view of the shutter mechanism shown in FIG. 32.

FIG. 34 is a schematic cross-sectional view of an optical drive system according to the ninth embodiment.

FIG. 35 is a schematic bottom view of a shutter mechanism of the optical drive system shown in FIG. 34.

FIG. 36 is a schematic bottom view of the shutter mechanism shown in FIG. 35.

FIG. 37 is a schematic cross-sectional view of an optical drive system according to the tenth embodiment.

FIG. 38A is a schematic plan view of a cartridge of the optical drive system shown in FIG. 37.

FIG. 38B is a schematic bottom view of the cartridge shown in FIG. 38A.

FIG. 39 is a schematic view of an optical drive system according to the eleventh embodiment.

FIG. 40 is a schematic view of a plasmon apparatus of the optical drive system shown in FIG. 39.

FIG. 41 is a schematic view of a cartridge of the optical drive system shown in FIG. 39.

FIG. 42 is a schematic view of a drive device used for a conventional optical drive system.

FIG. 43 is an enlarged schematic view of a collective element of the drive device shown in FIG. 42.

FIG. 44 is an enlarged schematic view of the drive device shown in FIG. 42.

FIG. 45 is a schematic bottom view of the drive device shown in FIG. 44.

FIG. 46A is a schematic view of a conventional lens cleaning mechanism.

FIG. 46B is a schematic view of the conventional lens cleaning mechanism.

FIG. 46C is a schematic view of the conventional lens cleaning mechanism.

FIG. 47 is a schematic flow chart of various operations of the drive device shown in FIG. 42.

### DETAILED DESCRIPTION OF THE INVENTION

Various features of an exemplary optical drive system are described with reference to the drawings. In the following embodiments, the same elements are denoted with the same reference symbols. Redundant explanations are omitted to clarify description. Configurations, arrangements and shapes shown in the drawings and description with reference to the drawings are intended to assist in understanding principle of the embodiments. Therefore, the principle of the embodiments is in no way limited thereto.

### (Common Features)

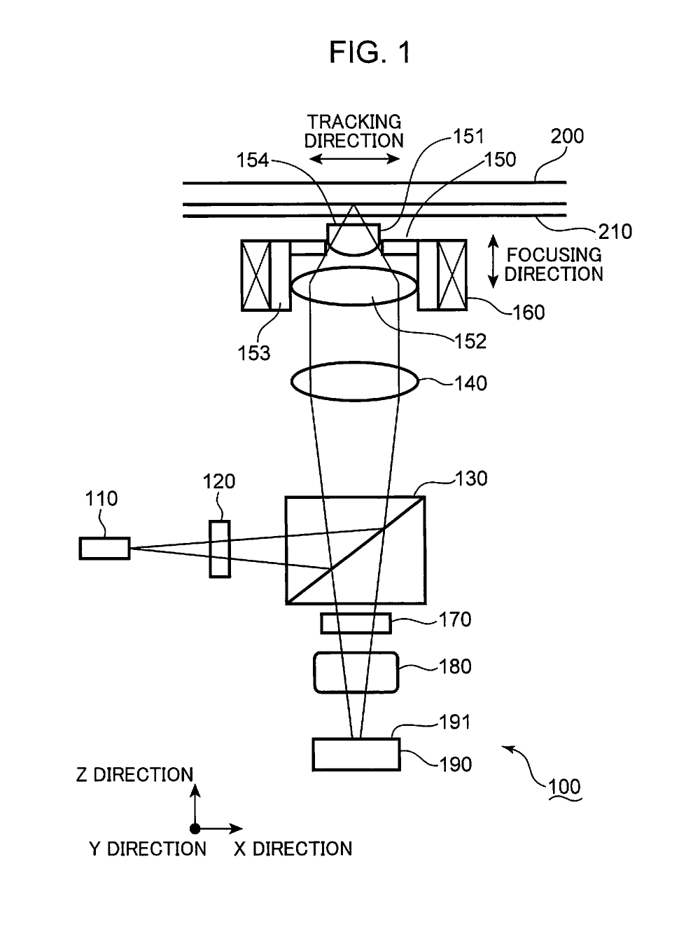

FIG. 1 is a schematic view of an exemplary optical head 100 integrated to the optical drive system. The optical head 100 is described with reference to FIG. 1. The optical head 100 may be commonly applied to the following optical drive systems of various embodiments.

The optical head 100 includes a semiconductor laser 110, a relay lens 120, a beam splitter 130, a collimator lens 140, an object lens portion 150, an actuator 160, a hologram element 170, a cylindrical lens 180 and a photo-detector 190. The semiconductor laser 110 functions as a light source and emits a laser beam toward the relay lens 120. The laser beam transmits through the relay lens 120 and enters the beam splitter 130. The beam splitter 130 reflects the laser beam toward the collimator lens 140. The laser beam then transmits through the collimator lens 140, and reaches the object lens portion 150.

FIG. 1 shows a part of a rotatable optical disk 200. The optical disk 200 is stored in a cartridge although the cartridge is not shown in FIG. 1. Various features of the cartridge are described later. In this embodiment, the optical disk 200 is exemplified as the record medium.

The laser beam reaching the object lens portion 150 is then emitted to the optical disk 200. The optical disk 200 reflects or diffracts the laser beam. In the following description, a reflected or diffracted laser beam is called “return light”.

The return light transmits through the object lens portion 150 and the collimator lens 140, and then enters the beam splitter 130 again. Since the beam splitter 130 allows passage of the return light, the return light transmits through the hologram element 170 and the cylindrical lens 180, and eventually reaches the photo-detector 190.

The object lens portion 150 faces the optical disk 200. The object lens portion 150 includes an SIL 151 and an aspherical lens 152. The laser beam reflected by the beam splitter 130 transmits through the aspherical lens 152, and then reaches the SIL 151. The return light transmits through the SIL 151 and then reaches the aspherical lens 152. In this embodiment, the SIL 151 and the aspherical lens 152 are exemplified as the optical element.

The object lens portion 150 further includes a lens holder 153 which holds the SIL 151 and the aspherical lens 152. The SIL 151 and the aspherical lens 152 are stored in the lens holder 153. In the embodiments, the lens holder 153 is exemplified as the holder.

The SIL 151 includes an SIL end surface 154 which faces the optical disk 200. The optical disk 200 includes a record surface 210 which faces the SIL end surface 154. The record surface 210 receives light emitted from the SIL end surface 154. The reflected light from the record surface 210 transmits through the SIL 151. Information is optically processed between the SIL end surface 154 and the record surface 210. Recording signals on the record surface 210 and reproducing signals from the record surface 210 are exemplified as the optical information process. In the embodiments, the record surface 210 is exemplified as the light receiving surface.

As mentioned above, the semiconductor laser 110 is used as a light source. The semiconductor laser 110 emits a laser beam toward the relay lens 120. The relay lens 120 finely adjusts a focal length between the semiconductor laser 110 and the relay lens 120. The laser beam transmitted through the relay lens 120 is reflected toward the collimator lens 140 by the beam splitter 130. The collimator lens 140 transforms the laser beam into a collimated beam. The collimated beam then enters the object lens portion 150.

The laser beam entering the object lens portion 150 is condensed toward the record surface 210 of the optical disk 200 by the aspherical lens 152 and the SIL 151, and becomes near-field light. The optical head 100 may use the near-field light to record signals on the record surface 210 of the optical disk 200. Alternatively, the optical head 100 may uses the near-field light to read signals recorded on the record surface 210. The near-field light reflected by the record surface 210 becomes the aforementioned return light. The return light enters the object lens portion 150. The signals recorded on the record surface 210 are reproduced by the return light.

The actuator 160 drives the object lens portion 150 in the focusing direction (optical axis direction) and the tracking direction (radial direction). The actuator 160 moves the object lens portion 150 in the focusing direction to appropriately adjust a distance between the record surface 210 and the SIL end surface 154. The actuator 160 moves the object lens portion 150 in the tracking direction to scan the record surface 210 by means of the near-field light resulting from the SIL 151. Consequently, signals may be recorded to and/or reproduced from the entire record surface 210.

The return light from the record surface 210 of the optical disk 200 transmits through the object lens portion 150 and the collimator lens 140, and then enters the beam splitter 130. The beam splitter 130 allows passage of the return light.

The return light transmitted through the beam splitter 130 enters the hologram element 170. The hologram element 170 generates tracking error signals on the basis of one beam method (APP method).

The return light transmitted through the hologram element 170 reaches the cylindrical lens 180. The return light transmitted through the cylindrical lens 180 then enters the photo-detector 190.

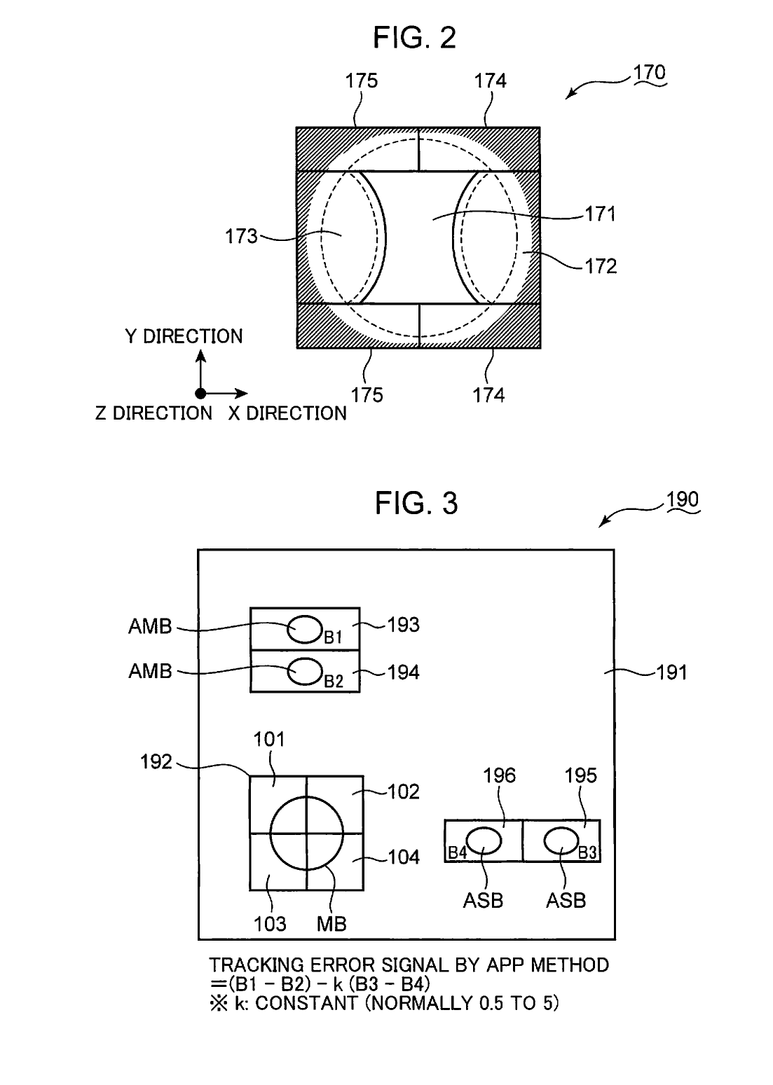

FIG. 2 is a schematic view of the hologram element 170. The hologram element 170 is described with reference to FIGS. 1 and 2.

Solid lines drawn in the hologram element 170 in FIG. 2 schematically show a dividing pattern of the hologram element 170. Dotted lines drawn in the hologram element 170 in FIG. 2 schematically show a shape (cross-section) of a laser beam which transmits through the hologram element 170.

The hologram element 170 is divided into a main beam area 171 at the center, APP main areas 172, 173 situated at the right and left of the main beam area 171, respectively, two APP sub-areas 174 situated above and below the APP main area 172, and two APP sub-areas 175 situated above and below the APP main area 173. Interference light of the ± first order light and zero order light, which is diffracted by the record surface 210 of the optical disk 200, enters the APP main areas 172, 173. Only the zero order light enters the APP sub-areas 174, 175.

FIG. 3 is a schematic view of the photo-detector 190. A relationship between the hologram element 170 and the photo-detector 190 is described with reference to FIGS. 1 to 3.

The photo-detector 190 includes a light receiving surface 191 which faces the hologram element 170. The light receiving surface 191 includes a quadrant light receiving area 192, APP main light receiving portions 193, 194, and APP sub-light receiving portions 195, 196. The laser beam transmitted through the main beam area 171 of the hologram element 170 enters the quadrant light receiving area 192. In the following description, the laser beam which transmits through the main beam area 171 is called the “main beam (MB)”. The laser beams transmitted through the APP main areas 172, 173 enter the APP main light receiving portions 193, 194, respectively. In the following description, the laser beam transmitted through the APP main areas 172, 173 is called the “APP main beam (AMB)”. The laser beams transmitted through the APP sub-areas 174, 175 enter the APP sub-light receiving portions 195, 196. In the following description, the laser beam transmitted through the APP sub-areas 174, 175 is called the “APP sub-beam (ASB)”

The quadrant light receiving area 192 includes a first area 101, a second area 102 situated at the right of the first area 101, a third area 103 situated below the first area 101, and a fourth area 104 situated below the second area 102. Focus error signals are generated in response to a difference between a sum signal of resultant signals from lights detected in the first and forth areas 101, 104 and a sum signal of resultant signals from lights detected in the second and third areas 102, 103. RF signals are generated in response to a sum total of resultant signals from lights detected in the first to fourth areas 101, 102, 103, 104.

Push-pull signals are generated in response to a difference between resultant signals from lights which are detected in the APP main light receiving portions 193, 194, respectively. Tracking error signals are generated on the basis of the APP (Advanced Push-Pull) method by means of a predetermined operation using the push-pull signals and resultant signals generated from lights which are detected in the APP sub-light receiving portions 195, 196, respectively. Under a tracking servo control by means of the tracking error signals, the object lens portion 150 follows a track on the record surface 210 of the optical disk 200.

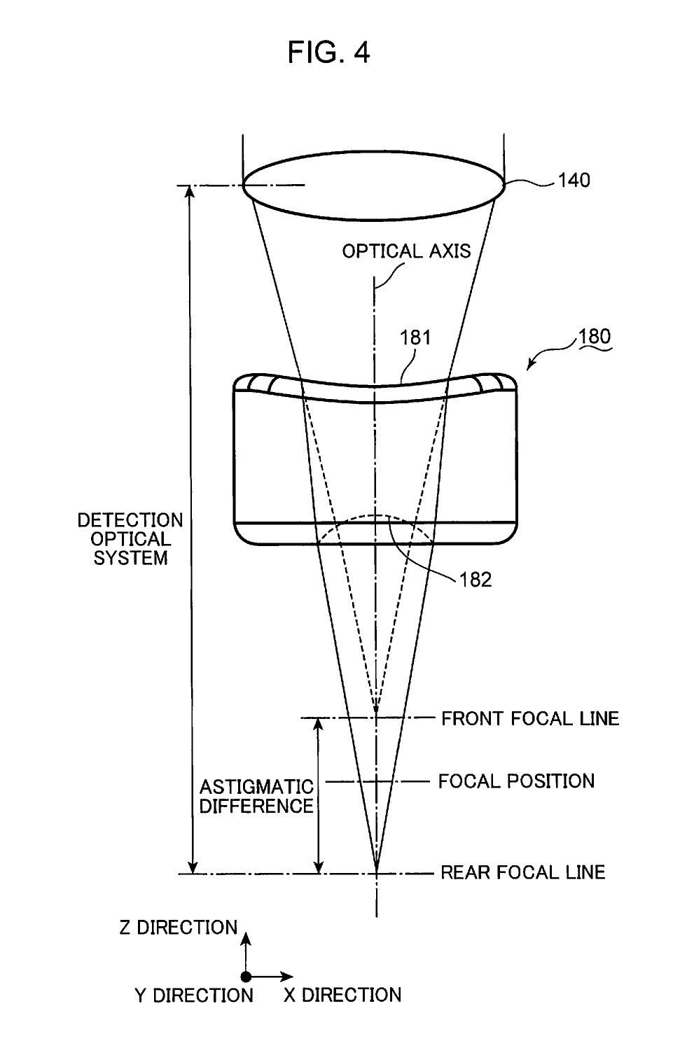

FIG. 4 is a schematic view of the cylindrical lens 180. The cylindrical lens 180 is described with reference to FIGS. 3 and 4.

The cylindrical lens 180 includes a concave lens surface 181, which faces the collimator lens 140, and a cylindrical surface 182 opposite to the concave lens surface 181. The cylindrical surface 182 causes an astigmatic difference defined by front and rear side focal lines on a plane which intersects the optical axis orthogonally. The cylindrical lens 180 forms a focal point between the front and rear side focal lines. The cylindrical surface 182 is inclined approximately 45° from the quadrant light receiving area 192 of the photo-detector 190.

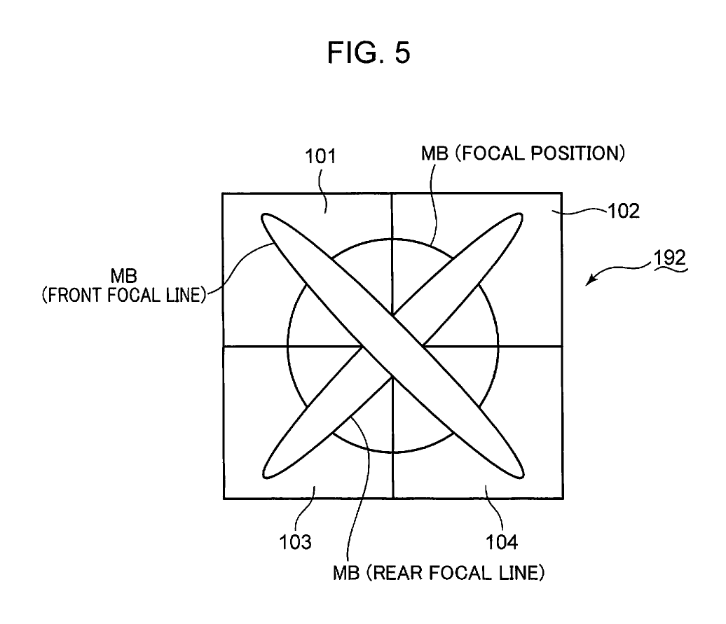

FIG. 5 is a schematic view of the quadrant light receiving area 192. The quadrant light receiving area 192 is described with reference to FIG. 1 and FIGS. 3 to 5.

The photo-detector 190 is situated so that the quadrant light receiving area 192 matches a focal position. If the quadrant light receiving area 192 matches the focal position, the main beam MB on the quadrant light receiving area 192 is approximately circular, as shown in FIG. 5.

If the record surface 210 vibrates in the focusing direction because of rotation of the optical disk 200, a relative distance between the record surface 210 and the object lens portion 150 fluctuates. As a result of the fluctuation of the relative distance between the record surface 210 and the object lens portion 150, the quadrant light receiving area 192 may match with the front or rear side focal line. If the quadrant light receiving area 192 matches with the front side focal line, the main beam MB becomes approximately an ellipse which extends between the first and fourth areas 101, 104, as shown in FIG. 5. If the quadrant light receiving area 192 matches with the rear side focal line, the main beam MB becomes approximately an ellipse which extends between the second and third areas 102, 103, as shown in FIG. 5.

### FIRST EMBODIMENT

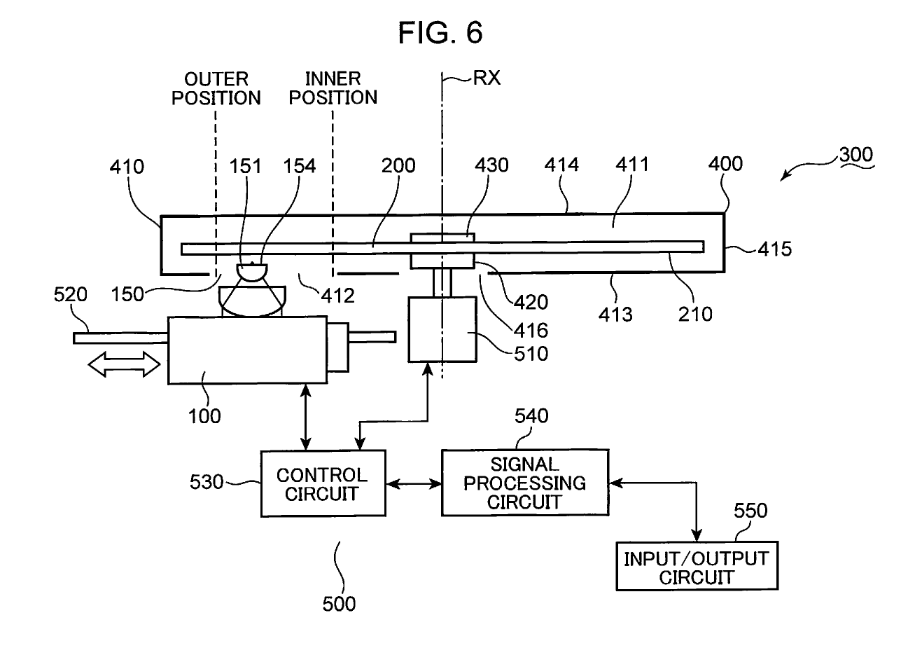

FIG. 6 is a schematic view of an optical drive system 300. The optical drive system 300 is described with reference to FIGS. 1, 3 and 6.

The optical drive system 300 includes a cartridge 400 having a wall portion 410 to define a storage room 411, in which the optical disk 200 is stored, and a drive device 500 configured to drive the optical disk 200 in the storage room 411. The drive device 500 rotates the optical disk 200 in the storage room 411. The drive device 500 performs optical information processes such as recording or reproducing signals on the optical disk 200 rotating in the storage room 411.

The cartridge 400 includes a chuck 430 and a turntable 420. The optical disk 200 is sandwiched by the chuck 430 and the turntable 420.

In addition to the optical head 100, the drive device 500 includes a spindle motor 510. The spindle motor 510 is connected to and rotates the turntable 420. Accordingly, the optical disk 200 rotates in the storage room 411. The spindle motor 510 is exemplified as the rotary driver. Alternatively, other apparatuses to rotate the optical disk 200 may be used as the rotary driver.

The drive device 500 further includes a traverse apparatus 520 configured to move the optical head 100 in the tracking direction. The optical head 100 is mounted on the traverse apparatus 520. The traverse apparatus 520 moves the optical head 100 between an inner position, at which the optical head 100 faces the record surface 210 of the optical disk 200 near the rotational axis RX defined by the spindle motor 510, and an outer position at which the optical head 100 faces the record surface 210 at a position more distant from the rotational axis RX than the inner position. Accordingly, a point of light on the record surface 210 (light emitted from the optical head 100) moves between the inner and outer positions. In this embodiment, the traverse apparatus 520 is exemplified as the movement driver. Alternatively, other apparatuses configured to move the optical head 100 between the inner and outer positions may be used as the movement driver.

The drive device 500 further includes a control circuit 530, a signal processing circuit 540 and an input/output circuit (hereafter “I/O circuit 550”). As mentioned above, the optical head 100 generates various signals in response to the return light from the optical disk 200. The optical head 100 outputs the generated signals to the control circuit 530. In response to the signals output from the optical head 100, the control circuit 530 executes various controls such as a focusing control, tracking control, traverse control and rotation control for the spindle motor 510. These controls may be based on known optical information processing technologies. The optical head 100 generates reproduction signals in response to the return light from the optical disk 200. The reproduction signals are output to the signal processing circuit 540 via the control circuit 530. The signal processing circuit 540 reproduces information in response to the reproduction signals. Signals containing information reproduced by the signal processing circuit 540 are output to the I/O circuit 550. The reproduction process may be based on known optical processing technologies. The I/O circuit 550 may receive signals, which contain information to be recorded on the optical disk 200, from an external apparatus (not shown). The signals input to the I/O circuit 550 are output to the optical head 100 via the signal processing circuit 540 and the control circuit 530. The optical head 100 may write the information on the optical disk 200 in response to the signals input to the I/O circuit 550. These writing techniques may be based on known optical processing technologies.

The wall portion 410 of the cartridge 400 includes a lower wall 413 provided with an opening 412, which extends from the outer position to the inner position, an upper wall 414, which faces the lower wall 413, and a surrounding wall 415 which connects circumferential edges of the lower and upper walls 413, 414. While the optical disk 200 rotates, air flow occurs in the storage room 411. By the air flow in the storage room 411, the air in the storage room 411 is exhausted from the opening 412 around the outer position. Therefore, the area of the opening 412 around the outer position functions as the outlet. The exhausting technologies through the opening 412 are described later. In this embodiment, the lower wall 413 is exemplified as the first wall. The upper wall 414 is exemplified as the second wall.

The cartridge 400 stores the optical disk 200. During processes such as recording or reproducing signals, a part of the object lens portion 150 (e.g. SIL 151 and lens holder 153) is inserted into the storage room 411 via the opening 412.

The optical drive system 300 uses near-field light to perform optical information processes such as recording and reproducing signals. Therefore, the optical drive system 300 has to appropriately control the object lens 150 so that a distance between the SIL end surface 154 and the record surface 210 becomes a distance to cause a near-field. In general, as a wavelength of a laser beam in use decreases, a distance (gap) between the SIL end surface and the record surface has to be set to several tens nm. In this embodiment, the distance (gap) between the SIL end surface 154 and the record surface 210 is set to 20 nm to 30 nm. The optical head 100 generates gap detection signals for detecting the distance (gap) between the SIL end surface 154 and the record surface 210. With the gap detection signals, the control circuit 530 performs gap control so as to maintain the distance (gap) between the SIL end surface 154 and the record surface 210 to be constant.

As mentioned above, the quadrant light receiving area 192 of the photo-detector 190 receives light reflected by the SIL end surface 154. If the control circuit 530 controls the optical head 100 so that a sum total of light quantity received by the quadrant light receiving area 192 (fully-reflected return light quantity) becomes constant, the distance between the SIL end surface 154 and the record surface 210 is maintained substantially constant.

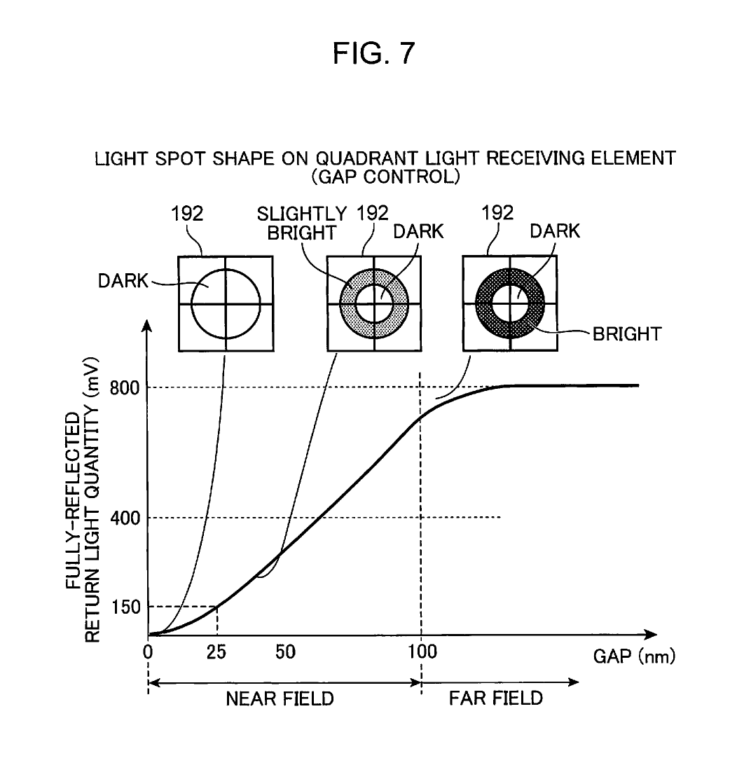

FIG. 7 is a schematic graph showing a fully-reflected return light quantity with respect to the gap. An exemplary gap control is described with reference to FIGS. 1, 6 and 7. The graph in FIG. 7 shows a shape of a light spot (reflected light from the SIL end surface 154) on the quadrant light receiving area 192.

In general, a gap not less than 100 nm is referred to as “far-field state” whereas a gap less than 100 nm is referred to as “near-field state”. With these terms, the gap control is described. Definitions of these terms in no way limit the principle of this embodiment.

If a relationship between the SIL end surface 154 and the record surface 210 is in the far-field state, the luminous flux, which corresponds to an area where the light is fully reflected (full reflection area) on the SIL end surface 154, enters the quadrant light receiving area 192. Therefore, a doughnut pattern light distribution is acquired on the quadrant light receiving area 192. If the SIL end surface 154 contacts the record surface 210, reflection is not observed in the full reflection area on the SIL end surface 154. Accordingly, the reflected light quantity from the SIL end surface 154 dramatically drops to approximately 0 mV. Refractive indexes of cover layers (thickness: approximately 1 μm) on surfaces of the SIL 151 and the optical disk 200 are both set to approximately 2.

In this embodiment, the control circuit 530 controls the actuator 160 so that fully-reflected return light quantity becomes approximately 150 mV, and moves the object lens portion 150 in the focusing direction. Accordingly, the gap becomes approximately 25 nm. The gap control depends on a gain setting of the light receiving surface 191 of the photo-detector 190. Therefore, the aforementioned numeric values do not limit the principle of this embodiment.

The focusing servo control for the object lens portion 150 may be based on known technologies. For example, a relative positional relationship between the aspherical lens 152 and the SIL 151 may be controlled. Alternatively, a position of the collimator lens 140 may be moved in the optical axis direction.

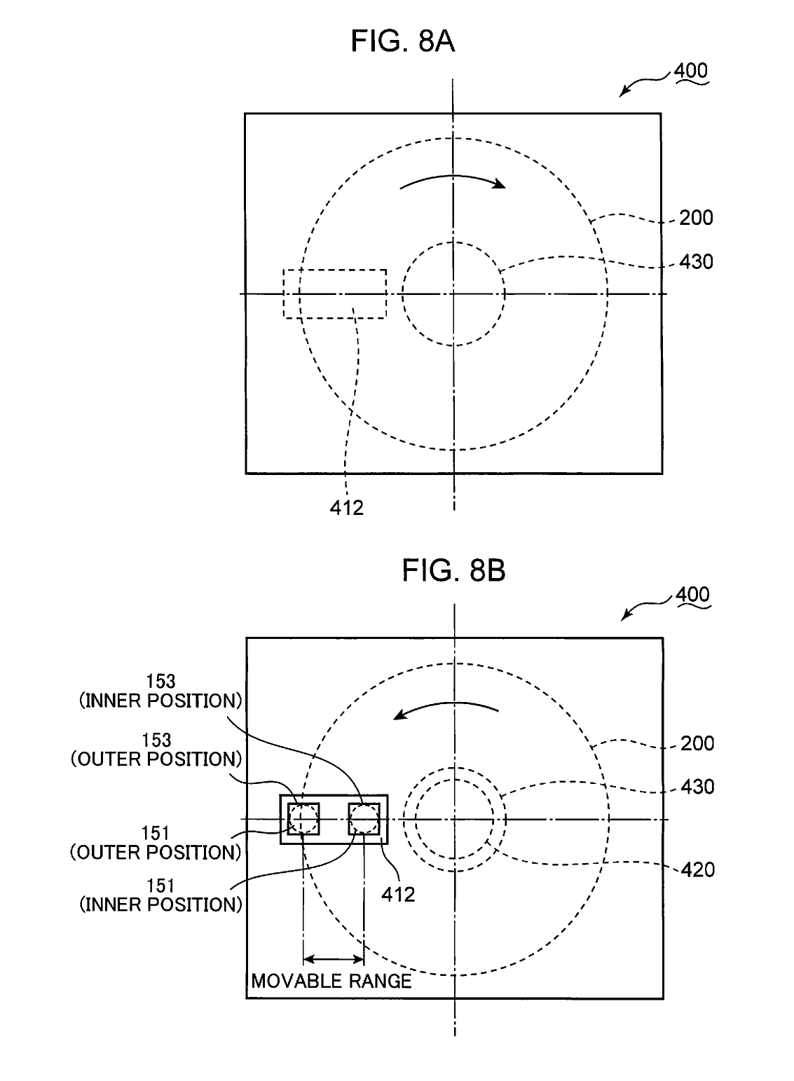

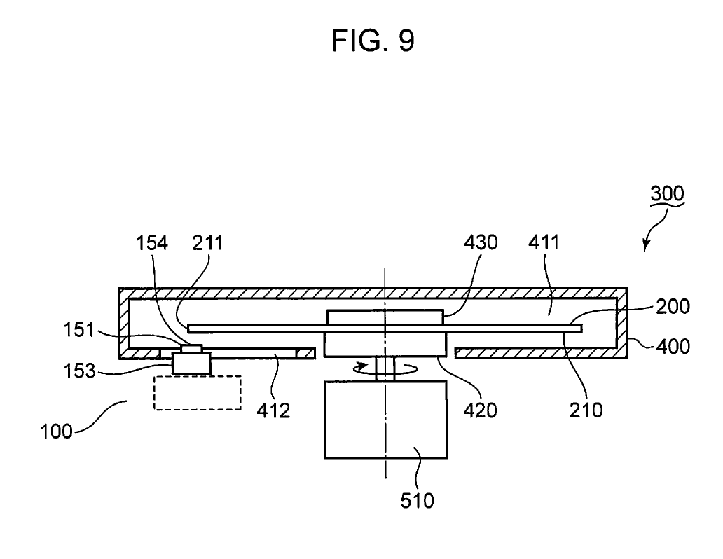

FIG. 8A is a schematic plan view of the cartridge 400. FIG. 8B is a schematic bottom view of the cartridge 400. FIG. 9 is an enlarged schematic cross-sectional view of the optical drive system 300 around the cartridge 400. The optical drive system 300 is described with reference to FIGS. 1, 6, 8A to 9.

As mentioned above, the cartridge 400 stores the optical disk 200. Therefore, dust does not adhere so much to the optical disk 200. In this embodiment, the cartridge prevents dust from adhering not only to the optical disk 200 but also to the SIL end surface 154.

The optical disk 200 is set on the turntable 420. The chuck 430 then sandwiches the optical disk 200 on the turntable 420. For example, the chuck 430 and the turntable 420 may magnetically sandwich the optical disk 200 by means of a magnetic force of magnets.

The optical disk 200 rotates as the spindle motor 510 connected to the turntable 420 rotates. The arrow in FIGS. 8A and 8B indicates rotation of the optical disk 200. The arrow in FIG. 9 indicates rotation of the spindle motor 510. In this embodiment, the optical disk 200 rotates clockwise. Alternatively, the optical disk 200 may rotate counterclockwise.

As shown in FIG. 1, the aspherical lens 152 and the SIL 151 are held by the lens holder 153. The lens holder 153 is supported by the actuator 160 via an elastic member (e.g. suspension). The support structure of the lens holder 153 may be based on known support technologies. The lens holder 153 is mounted on the actuator 160. Therefore, the lens holder 153 may move in the tracking direction (radial direction) and the focusing direction.

As shown in FIG. 6, the optical head 100 is mounted on the traverse apparatus 520. The traverse apparatus 520 moves the optical head 100 between the inner and outer positions. While the optical head 100 moves between the inner and outer positions, SIL 151 and a part of the lens holder 153 are inserted in the storage room 411 through the opening 412.

If the optical head 100 is situated at the inner position, the SIL end surface 154 faces the record surface 210 of the optical disk 200. If the optical head 100 is situated at the outer position, the SIL end surface 154 is situated just underneath the circumferential edge 211 of the optical disk 200.

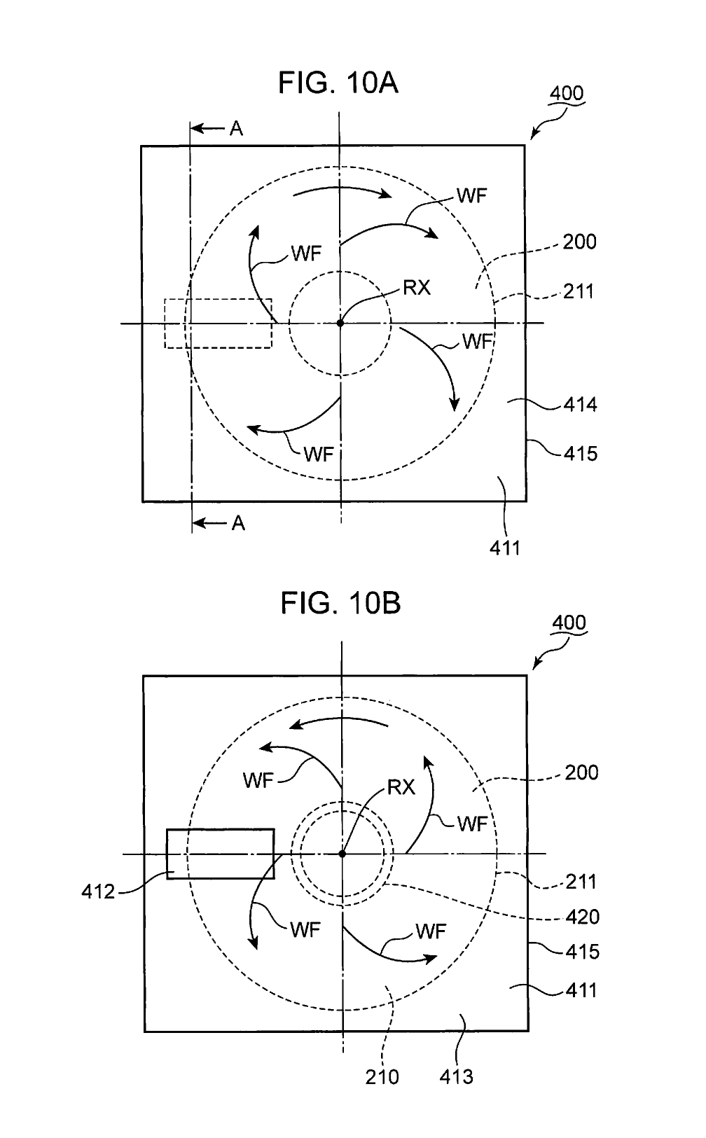

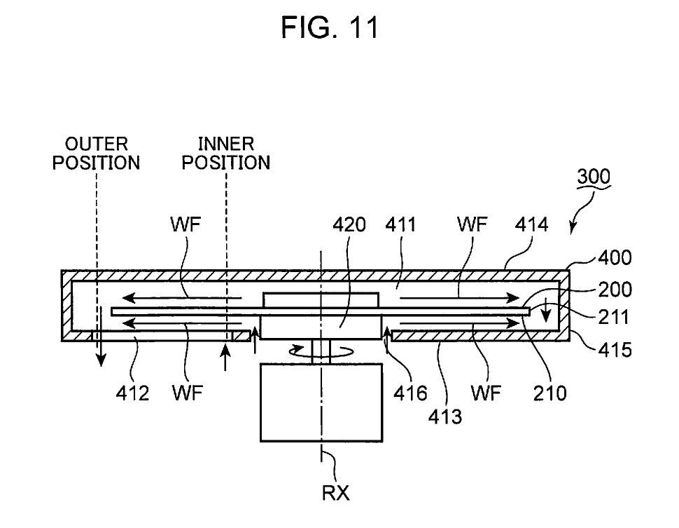

FIG. 10A is a schematic plan view of the cartridge 400. FIG. 10B is a schematic bottom view of the cartridge 400. FIG. 11 is an enlarged schematic cross-sectional view of the optical drive system 300 around the cartridge 400. FIG. 10A corresponds to FIG. 8A. FIG. 10B corresponds to FIG. 8B. FIG. 11 corresponds to FIG. 9. Air flow in the cartridge 400 is described with reference to FIGS. 10A to 11. In FIG. 11, components of the optical head 100 such as the lens holder 153 and the SIL 151 are omitted to clarify the air flow, unlike FIG. 9.

FIG. 10A is a schematic view showing a swirling flow WF caused between the top surface of the optical disk 200 and the upper wall 414 of the cartridge 400. As the optical disk 200 rotates, the swirling flow WF, which swirls in the rotational direction of the optical disk 200, is caused between the top surface of the optical disk 200 and the upper wall 414 of the cartridge 400. If a rotational speed of the optical disk 200 increases, a velocity of the swirling flow WF also increases. The velocity of the swirling flow WF increases as a position becomes more distant from the rotational axis RX of the optical disk 200. The velocity of the swirling flow WF around the rotational axis RX is low whereas the velocity of the swirling flow WF near the circumferential edge 211 of the optical disk 200 is high. Therefore, a pressure distribution generated in the storage room 411 increases pressure from the rotational axis RX to the surrounding wall 415 of the cartridge 400. The swirling flow WF caused between the top surface of the optical disk 200 and the upper wall 414 of the cartridge 400 is directed from the rotational axis RX to the surrounding wall 415 of the cartridge 400, so that a pressure near the circumferential edge 211 of the optical disk 200 becomes higher than a pressure around the rotational axis RX.

FIG. 10B is a schematic view showing a swirling flow WF which is caused between the bottom surface (record surface 210) of the optical disk 200 and the lower wall 413 of the cartridge 400. As the optical disk 200 rotates, the swirling flow WF, which swirls in the rotational direction of the optical disk 200, is caused between the bottom surface of the optical disk 200 and the lower wall 413 of the cartridge 400. If a rotational speed of the optical disk 200 increases, a velocity of the swirling flow WF also increases. The velocity of the swirling flow WF increases as a position becomes more distant from the rotational axis RX of the optical disk 200. The velocity of the swirling flow WF around the rotational axis RX is low whereas the velocity of the swirling flow WF near the circumferential edge 211 of the optical disk 200 is high. Therefore, a pressure distribution caused in the storage room 411 increases pressure from the rotational axis RX to the surrounding wall 415 of the cartridge 400. The swirling flow WF caused between the bottom surface of the optical disk 200 and the lower wall 413 of the cartridge 400 is directed from the rotational axis RX to the surrounding wall 415 of the cartridge 400, so that a pressure near the circumferential edge 211 of the optical disk 200 becomes higher than a pressure around the rotational axis RX.

As shown in FIG. 11, a center hole 416 is formed in the lower wall 413 of the cartridge 400, in addition to the opening 412. The center hole 416 is designed to be larger than the turntable 420 so that the turntable 420 may rotate. This means that a space is created around the turntable 420. As mentioned above, the pressure around the rotational axis RX is low. Therefore, external air outside the cartridge 400 is sucked into the storage room 411 through the space around the turntable 420. Consequently, the swirling flow WF is strengthened. Accordingly, the velocity of the swirling flow WF toward the surrounding wall 415 of the cartridge 400 increases. Air also flows into the storage room 411 from the area of the opening 412 around the inner position near the rotational axis RX due to the low pressure around the rotational axis RX.

As mentioned above, the swirling flow WF caused between the top surface of the optical disk 200 and the upper wall 414 of the cartridge 400 and the swirling flow WF caused between the bottom surface of the optical disk 200 and the lower wall 413 of the cartridge 400 flow toward the surrounding wall 415 of the cartridge 400. Air is sucked into the storage room 411 in the area of the space around the turntable 420 and the area of the opening 412 around the inner position. Consequently, the air in the storage room 411 is exhausted from the area of the opening 412 around the outer position. A sum total of an air amount sucked through the space around the turntable 420 and an air amount sucked through the area of the opening 412 around the inner position is approximately the same as an air amount exhausted from the area of the opening 412 around the outer position.

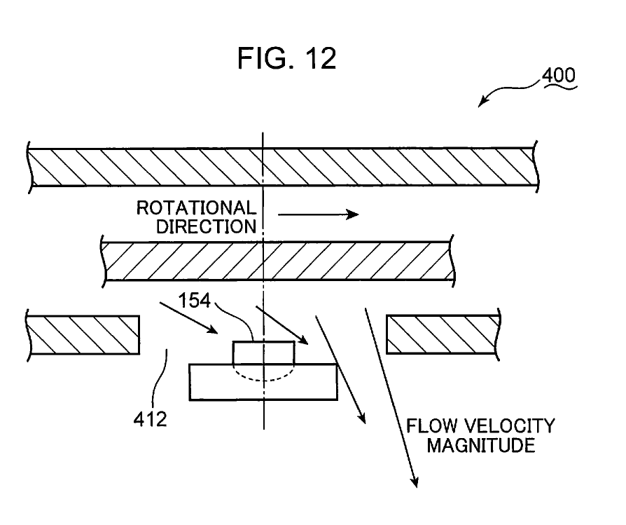

FIG. 12 is a schematic cross-sectional view of the cartridge 400 along the A-A line in FIG. 10A. Air flow exhausted from the opening 412 is described with reference to FIGS. 10A and 12.

The arrow directed downward from the opening 412 is a flow velocity vector of air exhausted from the opening 412. A length of the arrow indicates a magnitude of a flow velocity of the air exhausted from the opening 412. In the A-A cross-section, the air contacts the SIL end surface 154 diagonally. If the arrow is long, dust adhering to the SIL end surface 154 is effectively removed. In particular, if a vertical component of the flow velocity vector is large, the dust on the SIL end surface 154 is effectively removed without contact.

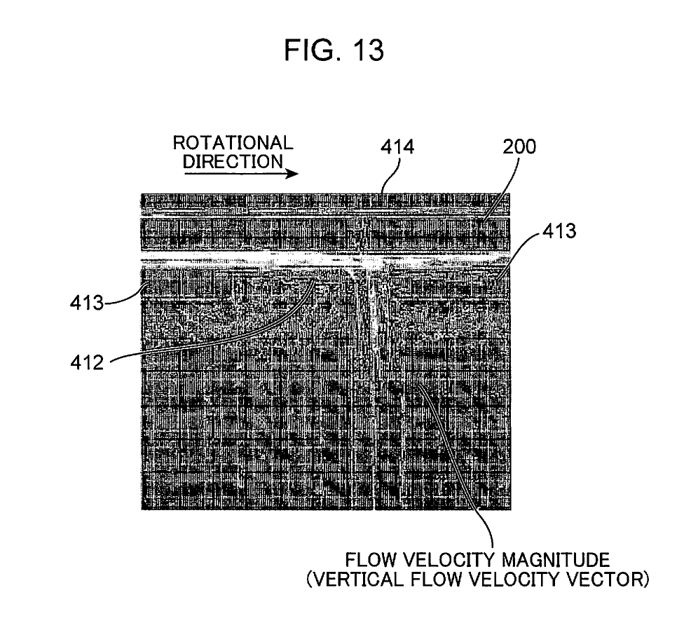

FIG. 13 shows exemplary computing results about the flow velocity of air exhausted from the opening 412 at the outer position. The air flow exhausted from the opening 412 is further described with reference to FIGS. 11 to 13.

If the optical disk 200 rotates at 6000 rpm, the air flow velocity exhausted from the opening 412 is approximately 5 m/sec. in the vertical direction. Air directed to the opening 412 is directly blown onto the SIL end surface 154 to remove dust adhering to the SIL end surface 154 without contact. Therefore, the aforementioned gap control is stabilized. Consequently, the optical drive system 300 becomes very reliable. The dust removal principle of this embodiment does not require a contact type lens cleaning mechanism. Therefore, a compact design of the optical drive system 300 is allowed.

The computing results in FIG. 13 are exemplary. The computing results about the air flow velocity exhausted from the opening 412 (magnitude of the air flow velocity) depend not only on rotational speed of the optical disk 200 but also on a thickness of the air layer between the optical disk 200 and the upper wall 414 of the cartridge 400, a thickness of the air layer between the optical disk 200 and the lower wall 413 of the cartridge 400, a diameter of the optical disk 200, a distance between the circumferential edge 211 of the optical disk 200 and the surrounding wall 415 of the cartridge 400, a size of the opening 412, a position of the opening 412 and a size of the space around the turntable 420.

In the computing results shown in FIG. 13, the thickness of the air layer between the optical disk 200 and the upper wall 414 of the cartridge 400, and the thickness of the air layer between the optical disk 200 and the lower wall 413 of the cartridge 400 are designed to be approximately 1 mm. The width of the space around the turntable 420 is also designed to be approximately 1 mm. The diameter of the optical disk 200 is designed to be 120 mm. The external dimensions of the cartridge 400 are designed to be 70 mm by 70 mm. The opening 412 is designed to extend from a position, which is away from the rotational axis RX (center point of the cartridge 400) by 18 mm, to a position which is away from the rotational axis RX (radial direction) by 65 mm. A width of the opening 412 (tangential direction) is designed to be 10 mm (symmetric with respect to the center of the optical disk 200).

In the computing results shown in FIG. 13, the optical disk 200 rotates clockwise. Even if the rotational direction of the optical disk 200 is counterclockwise, similar computing results are acquired.

### SECOND EMBODIMENT

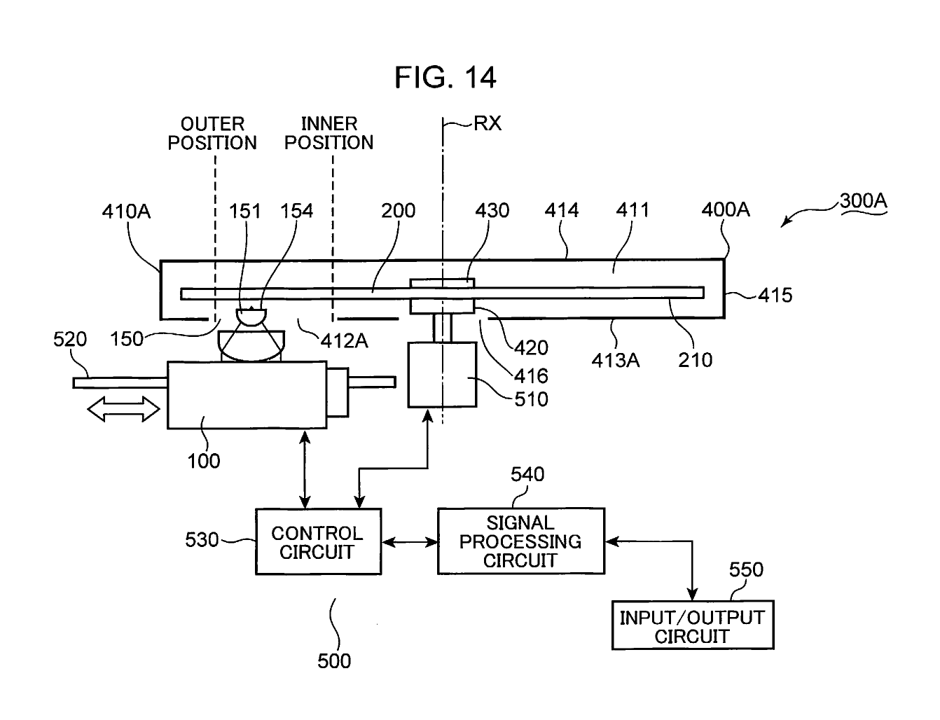

FIG. 14 is a schematic view of the optical drive system 300A according to the second embodiment. The optical drive system 300A is described with reference to FIGS. 6 and 14. In FIG. 14, the same elements as those described in the context of the first embodiment are denoted with the same reference symbols. Description about the elements denoted with the same reference symbols is omitted.

The optical drive system 300A includes a cartridge 400A, in addition to the drive device 500 described in the context of the first embodiment. The cartridge 400A includes a wall portion 410A, in addition to the chuck 430 and the turntable 420 which are described in the context of the first embodiment. The wall portion 410A includes a lower wall 413A, which partially closes the storage room 411, in addition to the upper wall 411 and the surrounding wall 415 which are described in the context of the first embodiment. In the lower wall 413A, an aperture 412A is formed, in addition to the center hole 416 described in the context of the first embodiment.

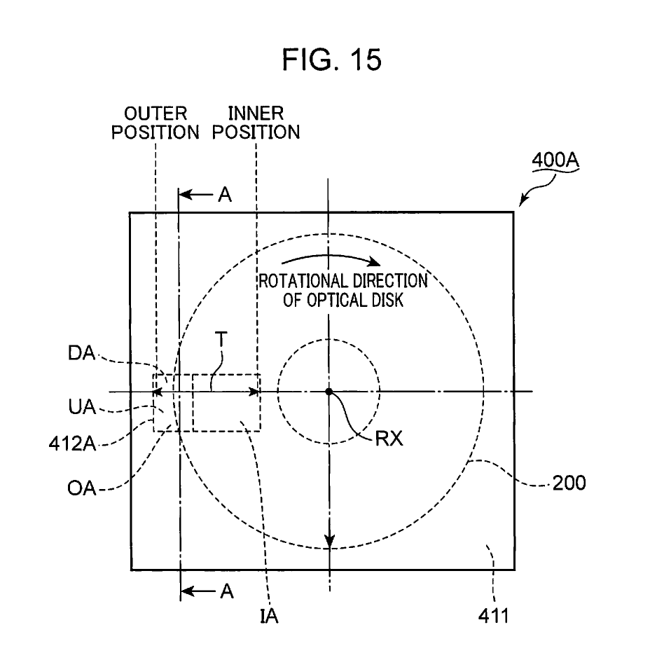

FIG. 15 is a schematic plan view of the cartridge 400A. The cartridge 400A is described with reference to FIGS. 14 and 15.

FIG. 15 shows a movement track T of the SIL 151 (i.e. scanning track of light from the SIL 151 on the record surface 210) in the opening 412A. The traverse apparatus 520 moves the SIL 151 along the opening 412A (i.e. along the movement track T). During this movement, optical information processes may be performed on the record surface 210 of the optical disk 200.

The dotted line conceptually divides the opening 412A into an area OA near the outer position and an area IA near the inner position. Air in the storage room 411 is mainly exhausted from the area OA. The movement track T conceptually divides the area OA into an upstream area UA and a downstream area DA. In the rotating direction of the optical disk 200, the upstream area UA is situated at an upstream position of the downstream area DA. The opening 412A is formed so that the upstream area UA is wider than the downstream area DA. In this embodiment, the downstream area DA is exemplified as the first opening region. The upstream area UA is exemplified as the second opening region. The opening size of the downstream area DA is exemplified as the first size. The opening size of the upstream area UA is exemplified as the second size.

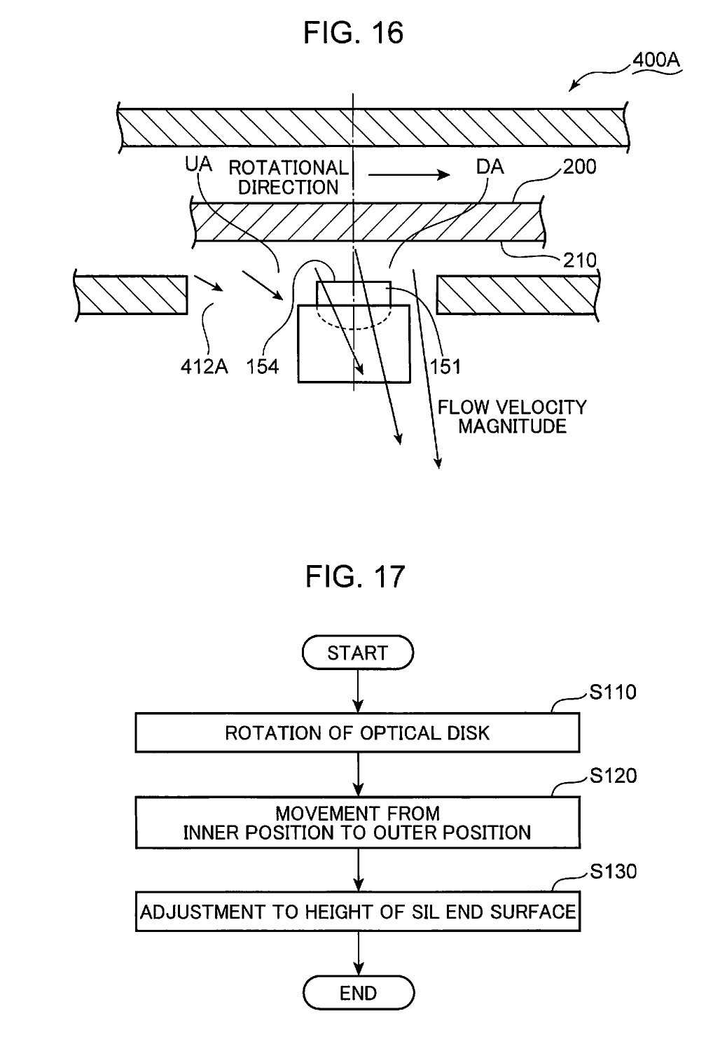

FIG. 16 is a schematic cross-sectional view of the cartridge 400A along the A-A line in FIG. 15. Air exhausted from the opening 412A is described with reference to FIGS. 15 and 16.

As described above, the upstream area UA is wider than the downstream area DA. Therefore, a flow velocity of the air blown onto the SIL end surface 154 is greater than the first embodiment. Consequently, dust adhering to the SIL end surface 154 is effectively removed without contact.

FIG. 17 is a schematic flow chart of a method for cleaning the SIL end surface 154. The method for cleaning the SIL end surface 154 is described with reference to FIGS. 1, 14 to 17.

### (Step S110)

The method for cleaning the SIL end surface 154 starts with step S110. In step S110, the optical disk 200 is rotated in the storage room 411. Then step S120 is executed.

### (Step S120)

In step S120, the control circuit 530 controls the traverse apparatus 520 to move the SIL 151 from the inner position to the outer position. Then step S130 is executed.

### (Step S130)

In step S130, the control circuit 530 controls the actuator 160 to adjust a distance from the record surface 210 or a surface extended from the record surface 210 to the SIL end surface 154. For example, the actuator 160 moves the SIL 151 in the focusing direction so that the SIL end surface 154 gets closer to the record surface 210 than step S120. Consequently, the SIL end surface 154 is exposed more strongly to the air flow exhausted from the opening 412A. In this embodiment, the record surface 210 or the surface extended from the record surface 210 is exemplified as the plane extending along the light receiving surface.

### THIRD EMBODIMENT

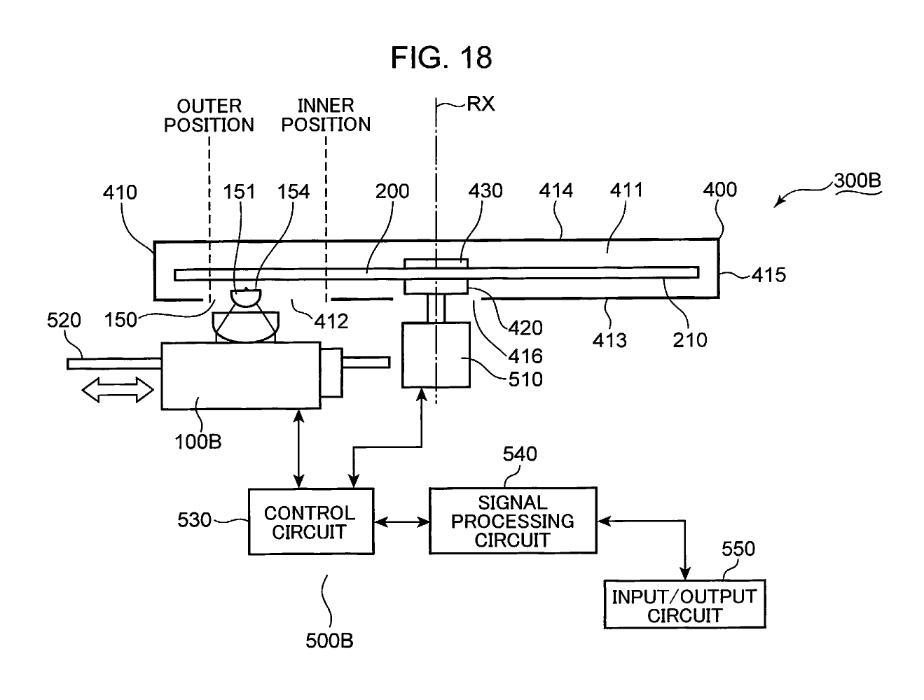

FIG. 18 is a schematic view of the optical drive system 300B according to the third embodiment. The optical drive system 300B is described with reference to FIGS. 6 and 18. In FIG. 18, the same elements as those described in the context of the first embodiment are denoted with the same reference symbols. Description about the elements denoted with the same reference symbols is omitted.

The optical drive system 300B includes a drive device 500B, in addition to the cartridge 400 described with reference to FIG. 1. The drive device 500B includes an optical head 100B, in addition to the traverse apparatus 520, the control circuit 530, the signal processing circuit 540 and the I/O circuit 550, which are described in the context of the first embodiment.

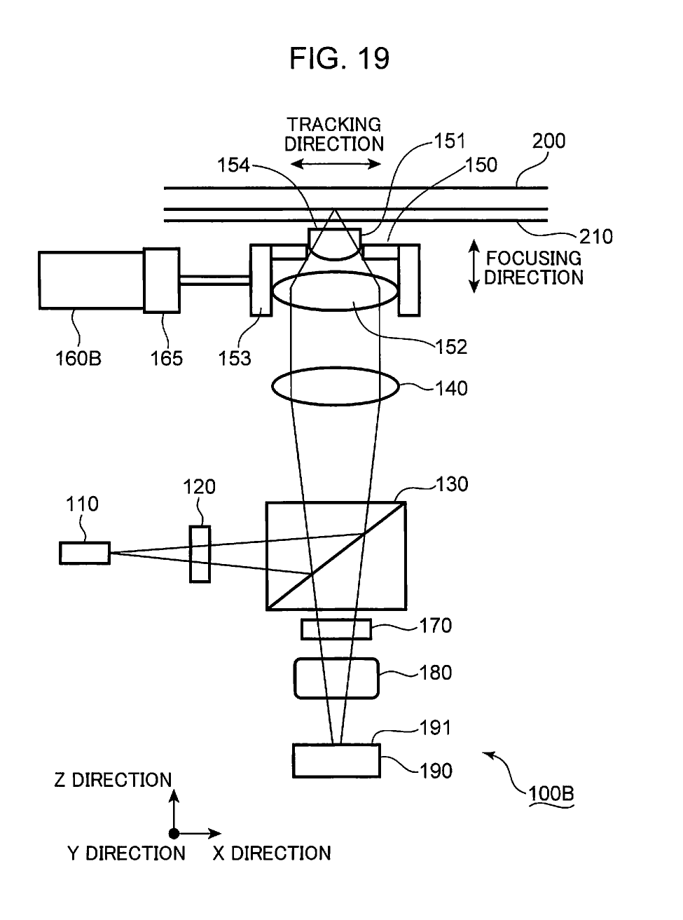

FIG. 19 is a schematic view of the optical head 100B. The optical head 100B is described with reference to FIGS. 1 and 19.

Like the first embodiment, the optical head 100B includes the semiconductor laser 110, the relay lens 120, the beam splitter 130, the collimator lens 140, the object lens portion 150, the hologram element 170, the cylindrical lens 180 and the photo-detector 190. The optical head 100B includes an elastic support structure 165, which is mounted on the lens holder 153, and an actuator 160B, which is connected to the lens holder 153 via the support structure 165. The actuator 160B moves the SIL 151 and the aspherical lens 152, which are supported by the lens holder 153, in the focusing direction and tracking direction (radial direction) by means of the supporting structure 165.

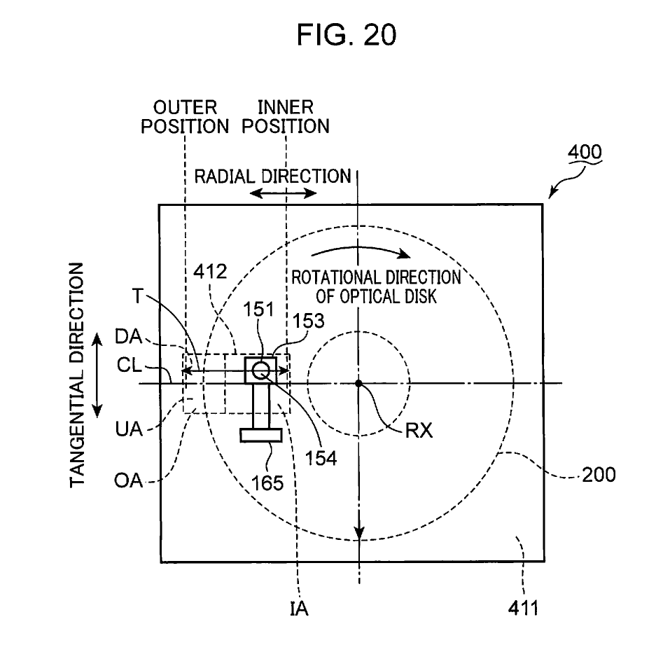

FIG. 20 is a schematic plan view of the cartridge 400. Movement of the SIL 151 in the opening 412 is described with reference to FIG. 20.

FIG. 20 shows the center line CL of the opening 412. The center line CL extends from the rotational axis RX of the optical disk 200 in the radius direction. FIG. 20 further shows the movement track T of the SIL 151. The support structure 165 holds the lens holder 153 so that the movement track T shifts to downstream of the center line CL in the rotational direction of the optical disk 200.

In FIG. 20, the dotted line conceptually divides the opening 412 into an area OA near the outer position and an area IA near the inner position. Air inside the storage room 411 is mainly exhausted via the area OA. Like the second embodiment, the movement track T divides the area OA into an upstream area UA and a downstream area DA. The upstream area UA is situated at an upstream position of the downstream area DA. Since the movement track T is shifted from the center line CL, the upstream area UA is wider than the downstream area DA. Therefore, the dust adhering to the SIL end surface 154 may be effectively removed.

In this embodiment, the holding position of the lens holder 153 is shifted from the center line CL. Alternatively, the optical head itself may be shifted in the tangential direction.

### FOURTH EMBODIMENT

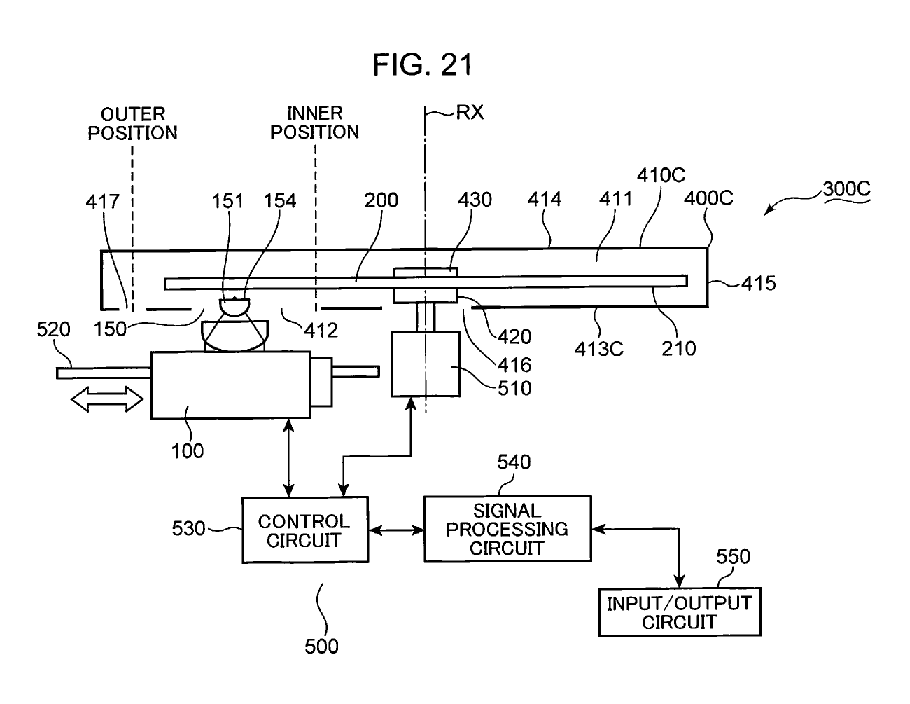

FIG. 21 is a schematic view of the optical drive system 300C according to the fourth embodiment. The optical drive system 300C is described with reference to FIGS. 6 and 21. In FIG. 21, the same elements as those described in the context of the first embodiment are denoted with the same reference symbols. Description about the elements denoted with the same reference symbols is omitted.

The optical drive system 300C includes a cartridge 400C, in addition to the drive device 500 described in the context of the first embodiment. The cartridge 400C includes a wall portion 410C, in addition to the chuck 430 and the turntable 420 which are described in the context of the first embodiment. The wall portion 410C includes a lower wall 413C configured to partially close the storage room 411, in addition to the upper wall 414 and the surrounding wall 415, which are described in the context of the first embodiment. In the lower wall 413C, an outlet 417 is formed, in addition to the opening 412 and the center hole 416 which are described in the context of the first embodiment. The opening 412 extending from the inner position in the radius direction is exclusively used for scanning on the record surface 210. Therefore, the traverse apparatus 520 moves the SIL 151 along the opening 412. The outlet 417, which is formed to be more distant from the rotational axis RX than the opening 412, is used for cleaning the SIL end surface 154. In this embodiment, the position, at which the outlet 417 is formed, is exemplified as the outer position.

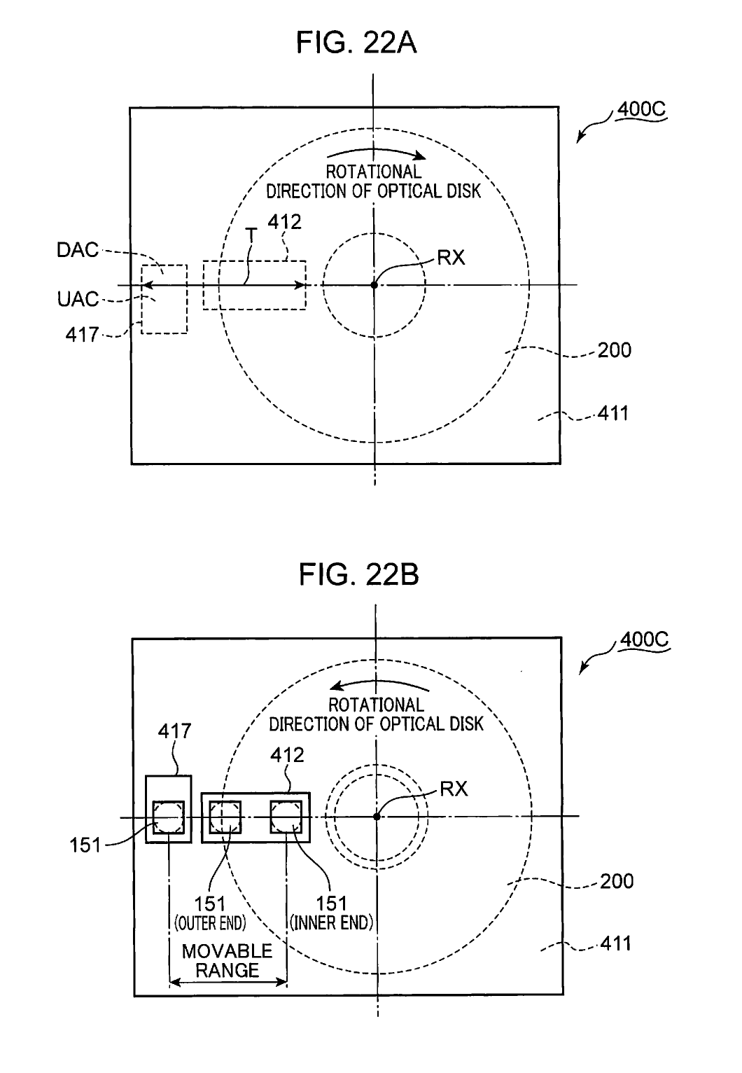

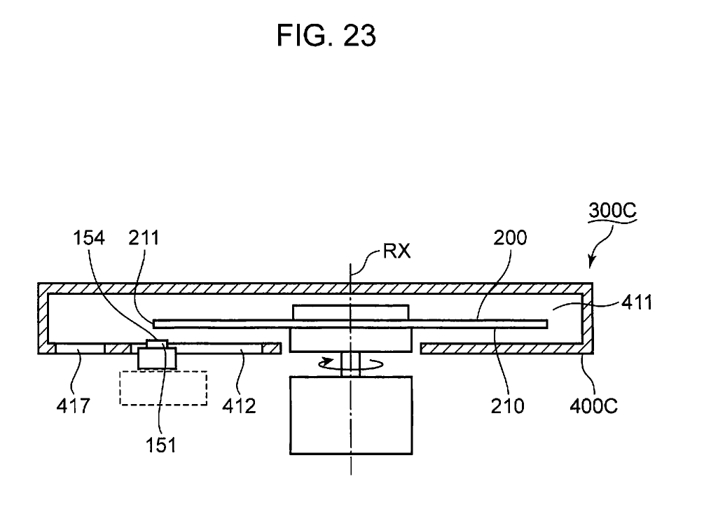

FIG. 22A is a schematic plan view of the cartridge 400C. FIG. 22B is a schematic bottom view of the cartridge 400C. FIG. 23 is an enlarged schematic cross-sectional view of the optical drive system 300C around the cartridge 400C. The optical drive system 300C is described with reference to FIGS. 1, 21 to 23.

FIG. 22A shows the movement track T of the SIL 151. The opening 412 is formed to be symmetric with respect to the movement track T whereas the outlet 417 is formed to be asymmetric with respect to the movement track T. The movement track T conceptually divides the outlet 417 into an upstream area UAC and a downstream area DAC. The upstream area UAC is situated at an upstream position of the downstream area DAC in the rotating direction of the optical disk 200. The outlet 417 is formed so that the upstream area UAC is wider than the downstream area DAC. In this embodiment, the downstream area DAC is exemplified as the first opening region. The upstream area UAC is exemplified as the second opening region. The opening size of the downstream area DAC is exemplified as the first size. The opening area of the upstream area UAC is exemplified as the second size.

FIG. 22B shows the SIL 151 situated at the inner end of the opening 412, the SIL 151 situated at the outer end of the opening 412, and the SIL 151 situated in the outlet 417. The traverse apparatus 520 may move the SIL 151 from the inner end of the opening 412 to the outlet 417. The traverse apparatus 520 may move the SIL 151 between the inner and outer ends of the opening 412 so as to optically scan the record surface 210. The SIL 151 situated at the outer end of the opening 412 is just below the circumferential edge 211 of the optical disk 200. The control circuit 530 may control the actuator 160 to move the SIL 151 downward. Consequently, the SIL 151 is drawn out of the opening 412. The traverse apparatus 520 may then move the SIL 151 outward. Once the SIL 151 reaches the outlet 417, the control circuit 530 may control the actuator 160 to insert the SIL 151 into the outlet 417.

The outlet 417 is more distant from the rotational axis RX than the outer end of the opening 412. Therefore, an air amount exhausted from the storage room 411 via the outlet 417 is more than that exhausted from an outer end area of the opening 412. This means that the air exhausted from the storage room 411 is blown more strongly onto the SIL end surface 154 than the first embodiment. Therefore, the optical drive system 300C may become very reliable.

In this embodiment, the outlet 417 is asymmetric with respect to the movement track T. Alternatively, the outlet 417 may be symmetric with respect to the movement track T.

### FIFTH EMBODIMENT

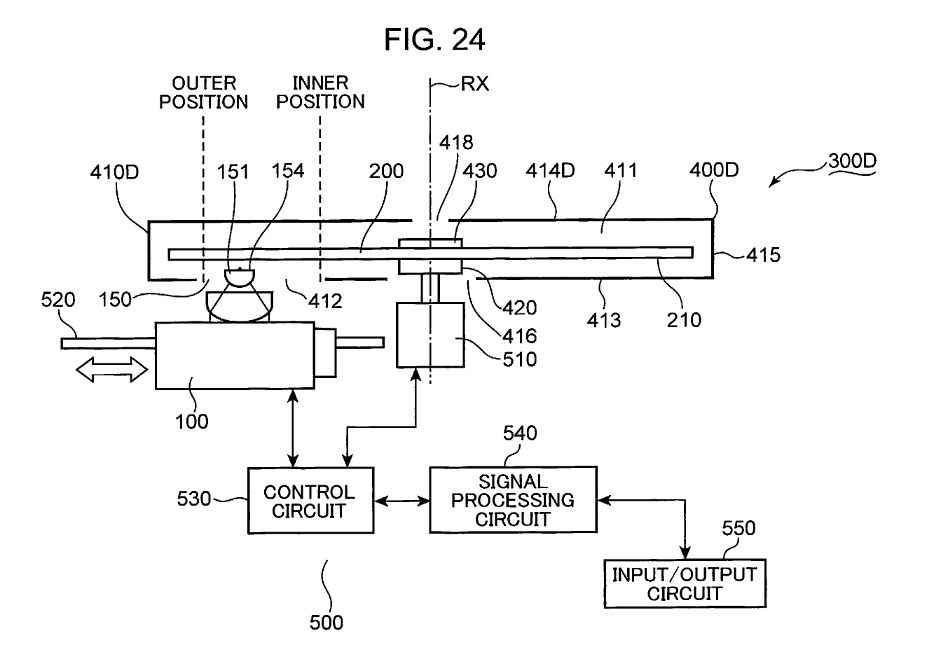

FIG. 24 is a schematic view of the optical drive system 300D according to the fifth embodiment. The optical drive system 300D is described with reference to FIGS. 6 and 24. In FIG. 24, the same elements as those described in the context of the first embodiment are denoted with the same reference symbols. Description about the elements denoted with the same reference symbols is omitted.

The optical drive system 300D includes a cartridge 400D, in addition to the drive device 500 described in the context of the first embodiment. The cartridge 400D includes a wall portion 410D, in addition to the chuck 430 and the turntable 420 which are described in the context of the first embodiment. The wall portion 410D includes an upper wall 414D which faces the lower wall 413, in addition to the lower wall 413 and the surrounding wall 415 which are described in the context of the first embodiment.

Unlike the first embodiment, an inlet 418 is formed in the upper wall 414D. The rotational axis RX of the optical disk 200 goes through the inlet 418. In this embodiment, a number of inlets 418 formed in the upper wall 414D is 1. Alternatively, a few inlets may be formed in the upper wall. Further alternatively, concentric openings about the rotational axis RX may be formed as the inlet.

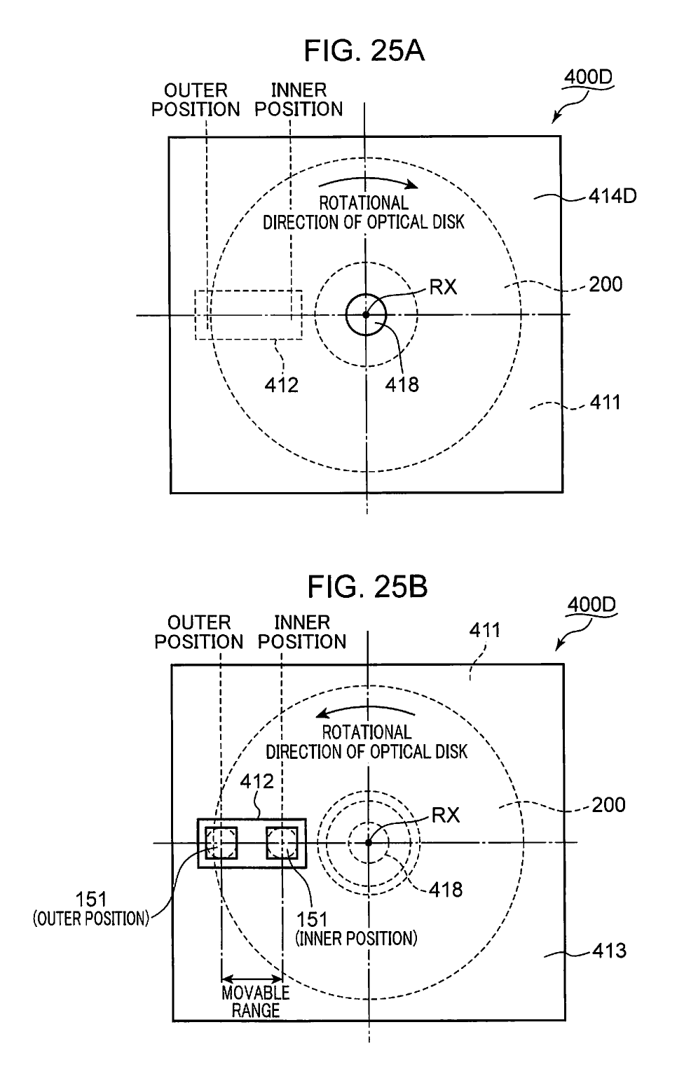

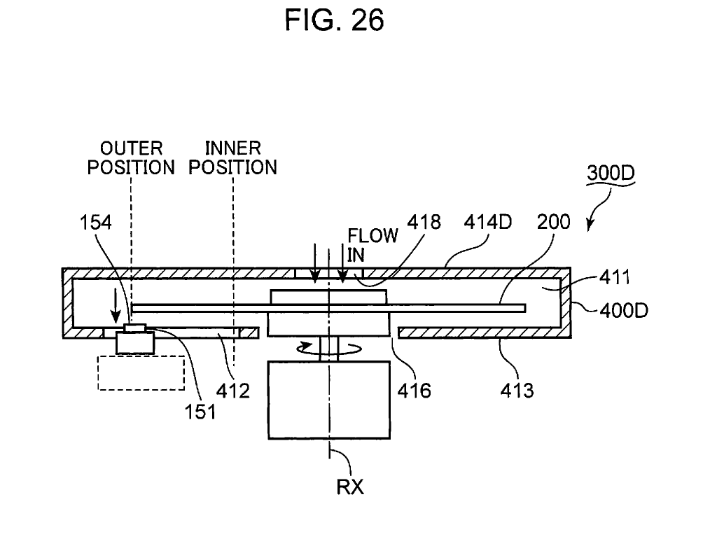

FIG. 25A is a schematic plan view of the cartridge 400D. FIG. 25B is a schematic bottom view of the cartridge 400D. FIG. 26 is an enlarged schematic cross-sectional view of the optical drive system 300D around the cartridge 400D. The optical drive system 300D is described with reference to FIGS. 24 to 26.

As described in the context of the first embodiment, rotation of the optical disk 200 causes negative pressure around the rotational axis RX. As mentioned above, in the upper wall 414D, the inlet 418 is formed around the rotational axis RX. Therefore, air flows into the storage room 411 not only through a center hole 416 formed in the lower wall 413 but also through the inlet 418. Since the air flowing into the storage room 411 increases, air exhausted from an area of the opening 412 around the outer position strongly hits the SIL 151 situated at the outer position. Since the air at high velocity is blown onto the SIL end surface 154, dust adhering to the SIL end surface 154 is effectively removed. Therefore, the optical drive system 300D becomes very reliable. In this embodiment, the upper wall 414D is exemplified as the second wall.

The structure of the upper wall 414D of this embodiment may be applied to the second to fourth embodiments to make non-contact type dust removal very effective. In this embodiment, the center of the inlet 418 matches the rotational axis RX. Alternatively, the inlet may be formed in a closer position to the inner position than the outer position if air is sucked into the storage room.

### SIXTH EMBODIMENT

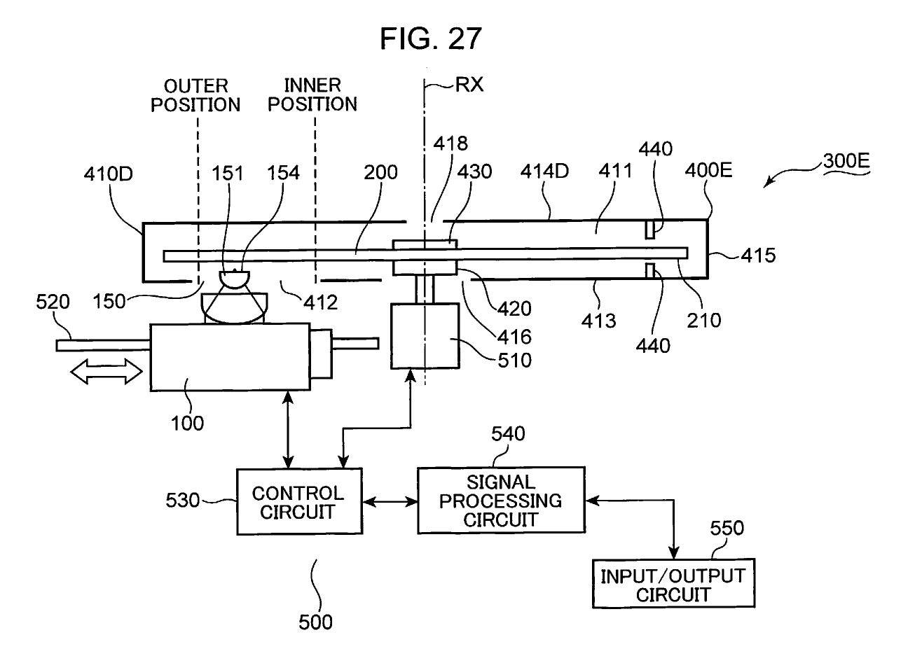

FIG. 27 is a schematic view of the optical drive system 300E according to the sixth embodiment. The optical drive system 300E is described with reference to FIGS. 24 and 27. In FIG. 27, the same elements as those described in the context of the fifth embodiment are denoted with the same reference symbols. Description about the elements denoted with the same reference symbols is omitted.

The optical drive system 300E includes a cartridge 400E, in addition to the drive device 500 described in the context of the fifth embodiment. The cartridge 400E includes filters 440, in addition to the chuck 430, the turntable 420 and the wall portion 410D which are described in the context of the fifth embodiment. The filters 440 are arranged above and below the optical disk 200, respectively. The filters 440 collect dust floating in the storage room 411. The filters 440 are secured to the upper and lower walls 414D, 413 with adhesive. Alternatively, the filters 440 may be inserted in grooves (not shown) formed in the upper and lower walls 414D, 413.

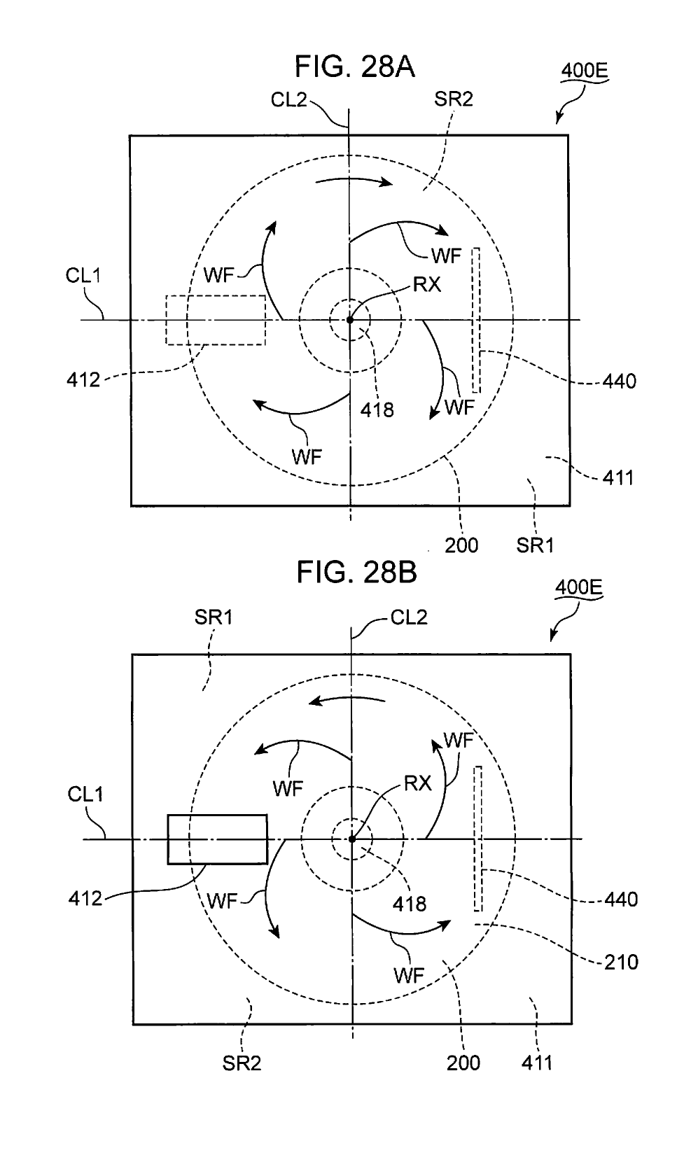

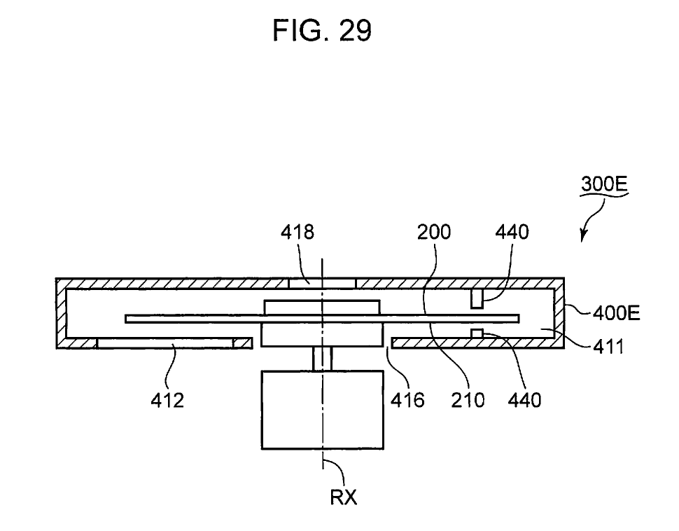

FIG. 28A is a schematic plan view of the cartridge 400E. FIG. 28B is a schematic bottom view of the cartridge 400E. FIG. 29 is an enlarged schematic cross-sectional view of the optical drive system 300E around the cartridge 400E. The optical drive system 300E is described with reference to FIGS. 27 to 29.

FIG. 28A shows a center line CL1, which extends in the extending direction of the opening 412, and a center line CL2, which intersects the center line CL1 orthogonally. The intersectional point between the center lines CL1, CL2 corresponds to the rotational axis RX of the optical disk 200. The opening 412 is formed at the left of the center line CL2 whereas the filter 440 is situated at the right of the center line CL2.

As described in the context of the fifth embodiment, air flows into the storage room 411 via the center hole 416 and the inlet 418 as the optical disk 200 rotates. As a result of the air flowing into the storage room 411, dust may enter the storage room 411.

The center line CL1 conceptually divides the storage room 411 into a first storage room SR1 and a second storage room SR2. The swirling flow WF in the first storage room SR1 is directed to the opening 412. Therefore, dust floating in the first storage room SR1 is exhausted from the opening 412. The swirling flow WF in the second storage room SR2 is directed to the filter 440. Therefore, dust floating in the second storage room SR2 is collected by the filter 440.

A particle diameter of dust floating in the storage room 411 is typically 50 nm or more. Therefore, it is preferable that the filter 440 may collect larger particles which is no less than 50 nm in diameter. If approximately 50% of dust included in the swirling flow WF, which passes through the filter 440, is collected, dust is less likely to adhere to the SIL 151. A collection efficiency of the filter 440 may be determined within a 5% to 100% range according to pressure loss of the filter 440.

Since the filter 440 dramatically decreases the dust floating in the storage room 411, dust is less likely to enter into a space between the SIL end surface 154 and the record surface 210. Consequently, the optical drive system 300E may become very reliable.

The filter 440 may be integrated into any one of the optical drive systems 300A to 300C of the second to fourth embodiments. If the optical drive systems 300A to 300C include the filter 440, the optical drive systems 300A to 300C may become very reliable.

### SEVENTH EMBODIMENT

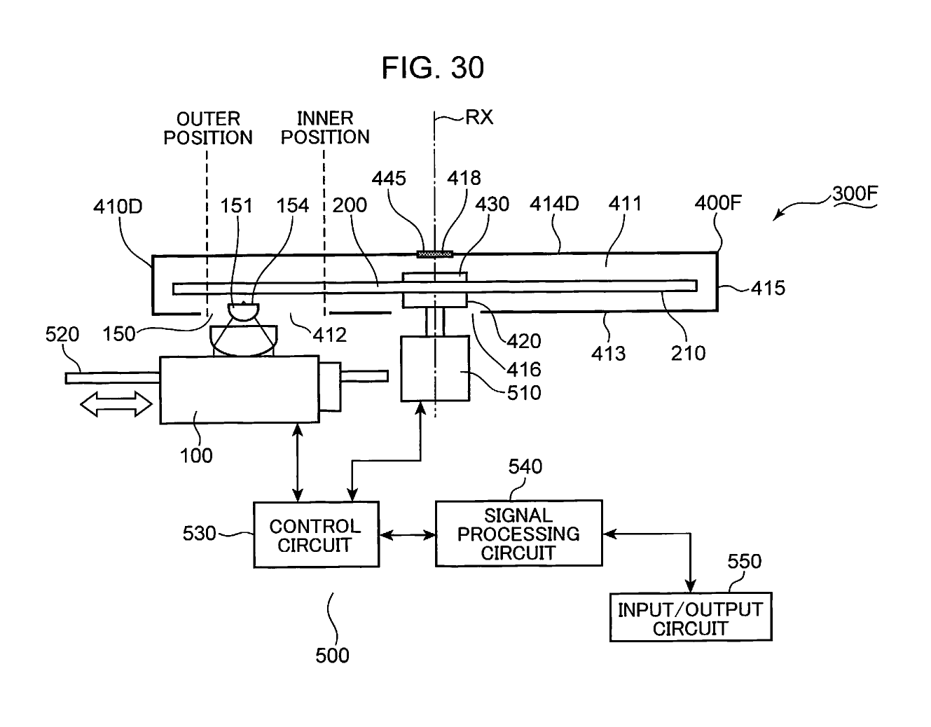

FIG. 30 is a schematic view of the optical drive system 300F according to the seventh embodiment. The optical drive system 300F is described with reference to FIGS. 24, 27 and 30. In FIG. 30, the same elements as those described in the context of the fifth or sixth embodiment are denoted with the same reference symbols. Description about the elements denoted with the same reference symbols is omitted.

The optical drive system 300F includes a cartridge 400F, in addition to the drive device 500 described in the context of the fifth embodiment. The cartridge 400F includes a filter 445, in addition to the chuck 430, the turntable 420 and the wall portion 410D which are described in the fifth embodiment. The filter 445 is situated in the inlet 418 to remove dust from air flowing from the inlet 418 into the storage room 411. The filter 445 may have similar characteristics as the filter 440 described in the context of the sixth embodiment.

### EIGHTH EMBODIMENT

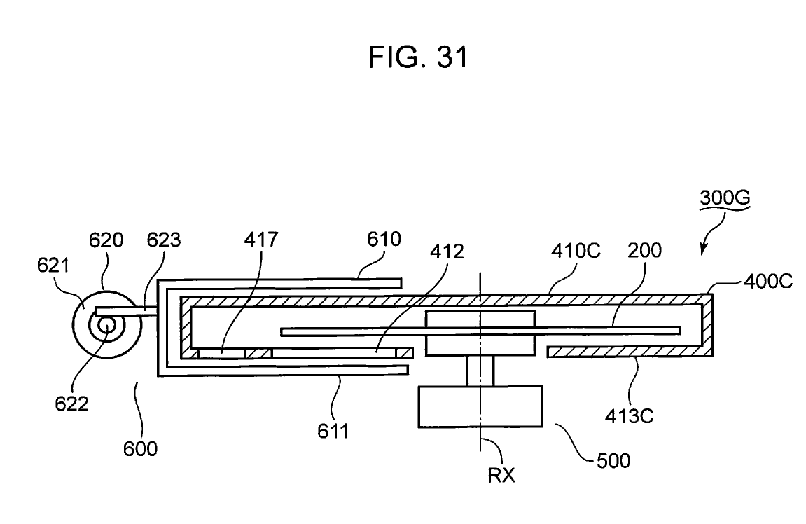

FIG. 31 is a schematic cross-sectional view of the optical drive system 300G according to the eighth embodiment. The optical drive system 300G is described with reference to FIGS. 21 and 31. In FIG. 31, the same elements as those described in the context of the fourth embodiment are denoted with the same reference symbols. Description about the elements denoted with the same reference symbols is omitted.

The optical drive system 300G includes the drive device 500 and the cartridge 400C, like the fourth embodiment. The optical drive system 300G further includes a shutter mechanism 600. The shutter mechanism 600 includes a shutter piece 610, which partially covers the wall portion 410C, and a shutter driving mechanism 620 configured to drive the shutter piece 610.

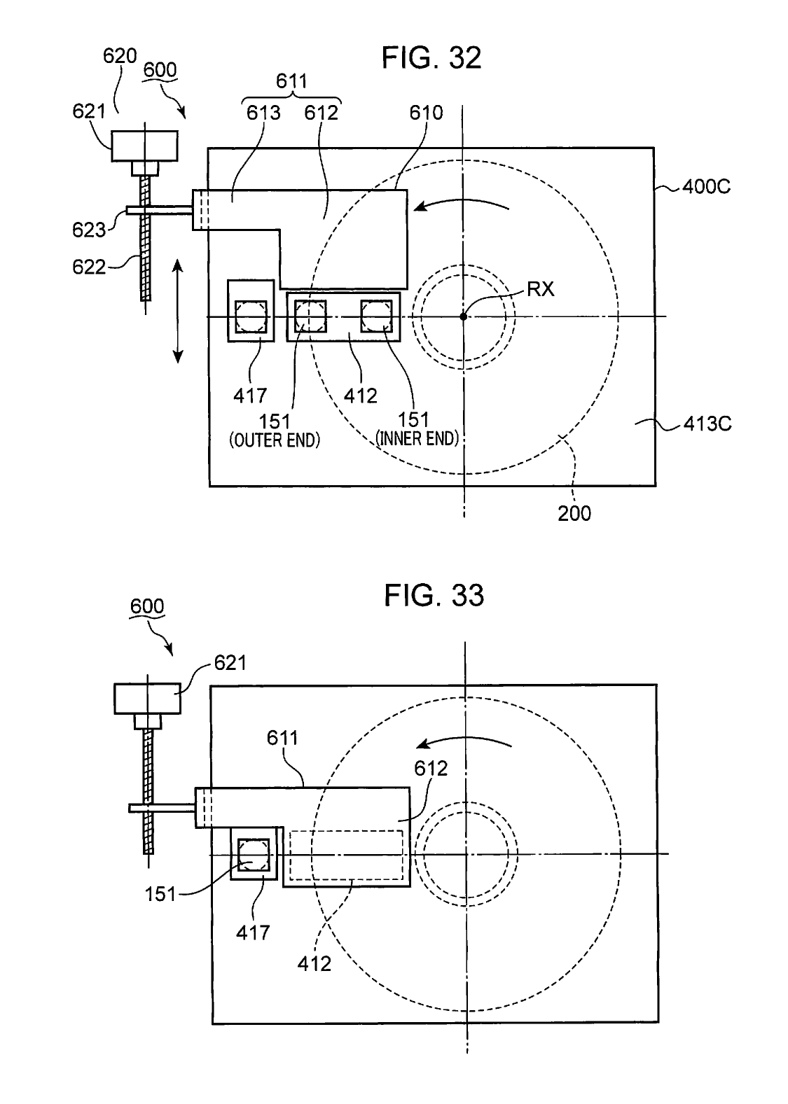

FIG. 32 is a schematic bottom view of the shutter mechanism 600. The shutter mechanism 600 is described with reference to FIGS. 31 and 32.

The shutter piece 610 includes a lower shutter plate 611 adjacent to the lower wall 413C of the cartridge 400C. The lower shutter plate 611 includes an inner plate 612 situated near the rotational axis RX of the optical disk 200, and an outer plate 613 which is more distant from the rotational axis RX than the inner plate 612.

The lower shutter plate 611 shown in FIG. 32 is situated at an open position, so that the opening 412 and the outlet 417 are exposed from the lower shutter plate 611. Therefore, while the lower shutter plate 611 is situated at the open position, the SIL 151 may move between the outer and inner ends of the opening 412.

If the lower shutter plate 611 is situated at the open position, the inner plate 612 is adjacent to the opening 412 whereas the outer plate 613, which is thinner than the inner plate 612, is apart from the outlet 417.

The shutter driving mechanism 620 includes a motor 621, a lead screw 622, which extends from the motor 621 in a perpendicular direction to the extending direction of the opening 412, and a spring member 623 connected to the outer plate 613 and the lead screw 622. The motor 621 rotates the lead screw 622. As a result of the rotation of the lead screw 622, the lower shutter plate 611 connected to the lead screw 622 by the spring element 623 is moved in the extending direction of the lead screw 622.

FIG. 33 is a schematic bottom view of the shutter mechanism 600. The shutter mechanism 600 is described with reference to FIGS. 32 and 33.

The lower shutter plate 611 shown in FIG. 33 is moved from the open position shown in FIG. 32 to the close position by driving operation of the motor 621. While the lower shutter plate 611 is situated at the close position, the inner plate 612 closes the opening 412 whereas the outlet 417 is exposed from the lower shutter plate 611. Therefore, while the lower shutter plate 611 is situated at the close position, the SIL 151 may be inserted into the outlet 417. In this embodiment, the lower shutter plate 611 is exemplified as the first shutter.

Since the lower shutter plate 611 closes the opening 412, an air amount exhausted from the outlet 417 increases to effectively remove dust adhering to the SIL 151.

### NINTH EMBODIMENT

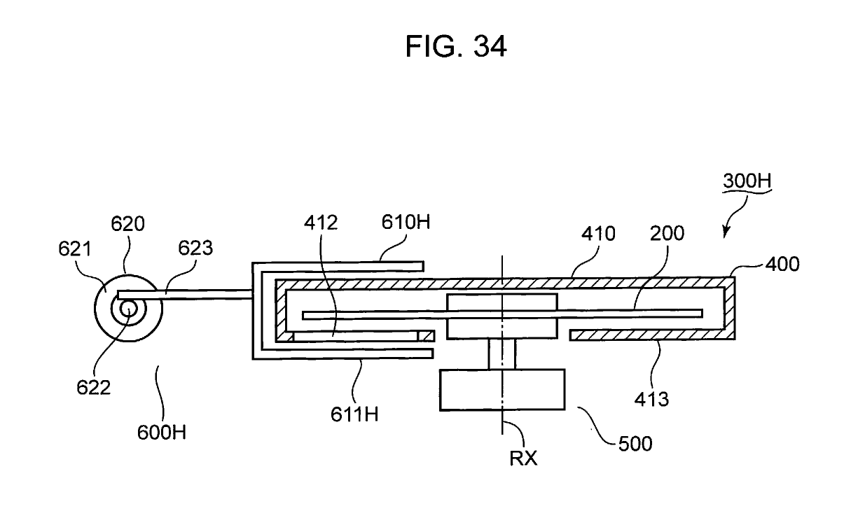

FIG. 34 is a schematic cross-sectional view of the optical drive system 300H according to the ninth embodiment. The optical drive system 300H is described with reference to FIGS. 6, 31 and 34. In FIG. 34, the same elements as those described in the first or eighth embodiment are denoted with the same reference symbols. Description about the elements denoted with the same reference symbols is omitted.

The optical drive system 300H includes the drive device 500 and the cartridge 400, like the first embodiment. The optical drive system 300H further includes a shutter mechanism 600H. The shutter mechanism 600H includes the shutter driving mechanism 620, like the eighth embodiment. The shutter mechanism 600H further includes a shutter piece 610H which is driven by the shutter driving mechanism 620.

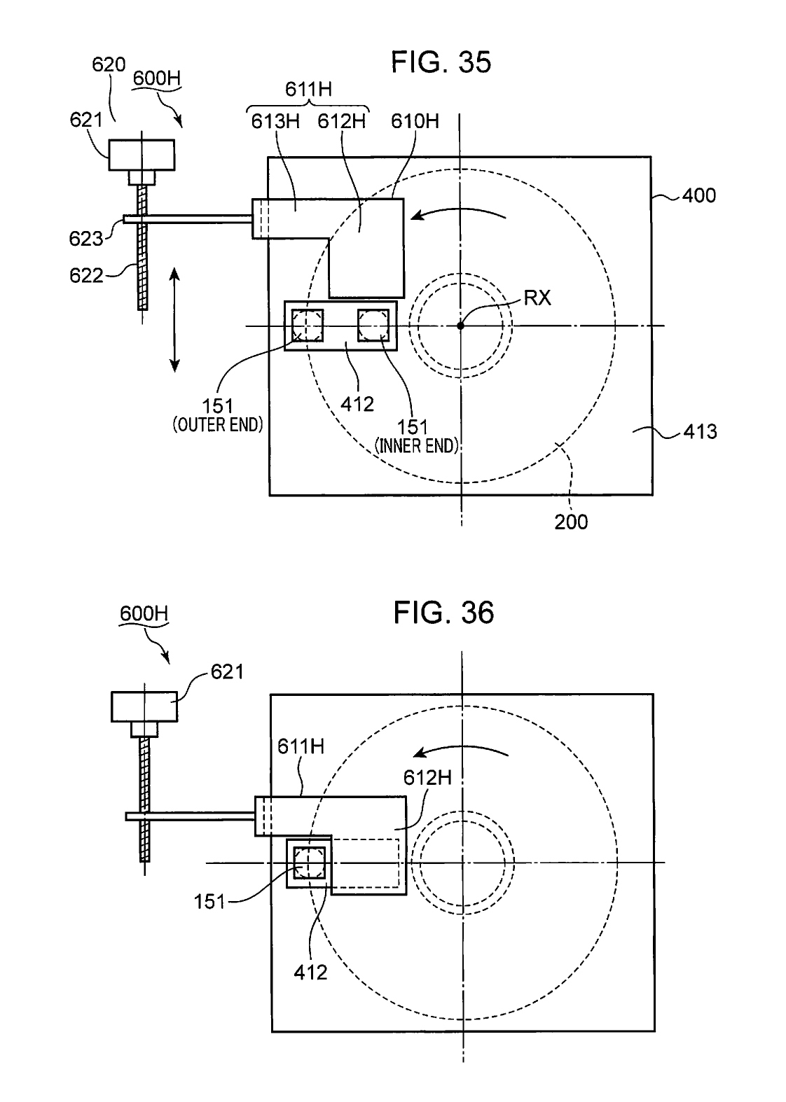

FIG. 35 is a schematic bottom view of the shutter mechanism 600H. The shutter mechanism 600H is described with reference to FIGS. 34 and 35.

The shutter piece 610H includes a lower shutter plate 611H adjacent to the bottom wall 413 of the cartridge 400. The lower shutter plate 611H includes an inner plate 612H situated near the rotational axis RX of the optical disk 200 and an outer plate 613H which is more distant from the rotational axis RX than the inner plate 612H.

The lower shutter plate 611H shown in FIG. 35 is situated at the open position, so that the opening 412 is exposed from the lower shutter plate 611H. Therefore, while the lower shutter plate 611H is situated at the open position, the SIL 151 may move between the outer end (i.e. the outer position) and the inner end (i.e. the inner position) of the opening 412.

If the lower shutter plate 611H is situated at the open position, the inner plate 612H is adjacent to the opening 412 around the inner position whereas the outer plate 613, which is thinner than the inner plate 612H, is apart from the opening 412.

FIG. 36 is a schematic bottom view of the shutter mechanism 600H. The shutter mechanism 600H is described with reference to FIGS. 35 and 36.

The lower shutter plate 611H shown in FIG. 36 is moved from the open position shown in FIG. 35 to the close position by driving operation of the motor 621. While the lower shutter plate 611H is situated at the close position, an area around the outer end of the opening 412 is exposed from the lower shutter plate 611H. Therefore, after the SIL 151 is moved to the outer end of the opening 412, the lower shutter plate 611H may move to the close position without interfering with the SIL 151. In this embodiment, the lower shutter plate 611H is exemplified as the first shutter.

Since the lower shutter plate 611H partially closes the opening 412, an air amount exhausted from an outer end area of the opening 412 increases. Therefore, dust adhering to the SIL 151 is effectively removed.

The shutter mechanism 600H of this embodiment may be used for the optical drive systems 300A, 300B of the second and third embodiments. If the shutter mechanism 600H is used for the optical drive system 300A or 300B, dust adhering to the SIL 151 is effectively removed.

### TENTH EMBODIMENT

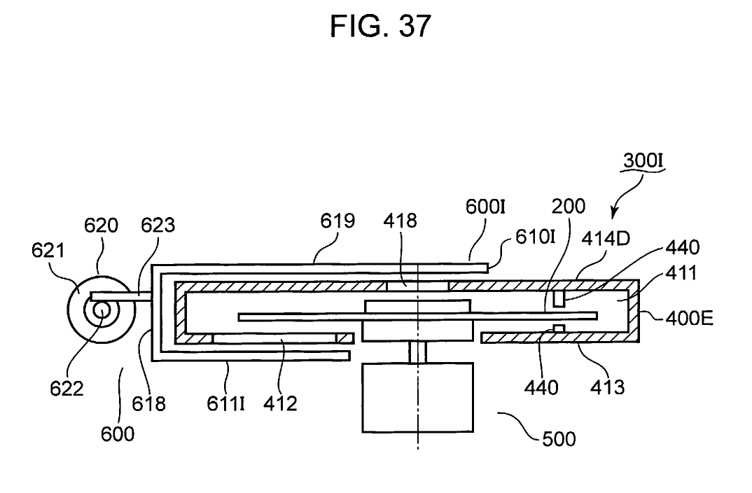

FIG. 37 is a schematic cross-sectional view of the optical drive system 300I according to the tenth embodiment. The optical drive system 300I is described with reference to FIGS. 27, 34 and 37. In FIG. 37, the same elements as those described in the context of the sixth, eighth or ninth embodiment are denoted with the same reference symbols. Description about the elements denoted with the same reference symbols is omitted.

The optical drive system 300I includes the drive device 500 and the cartridge 400E, like the sixth embodiment. The optical drive system 300I further includes a shutter mechanism 600I. The shutter mechanism 600I includes the shutter driving mechanism 620, like the eighth embodiment. The shutter mechanism 600I further includes a shutter piece 610I which is driven by the shutter driving mechanism 620.

The shutter piece 610I includes a lower shutter plate 611I adjacent to the lower wall 413 of the cartridge 400E, an upper shutter plate 619 adjacent to the upper wall 414D and an intermediate plate 618 connected to the lower and upper shutter plates 611I, 619. The spring member 623 of the shutter driving mechanism 620 is connected to the intermediate plate 618. The shutter driving mechanism 620 moves the shutter piece 610I between the open and close positions, like the eighth and ninth embodiments. The upper and lower shutter plates 619, 611I are connected by the intermediate plate 618, so that the upper and lower shutter plates 619, 611I move between the open and close positions in conjunction with each other. In this embodiment, the lower shutter plate 611I is exemplified as the first shutter. The upper shutter plate 619 is exemplified as the second shutter.

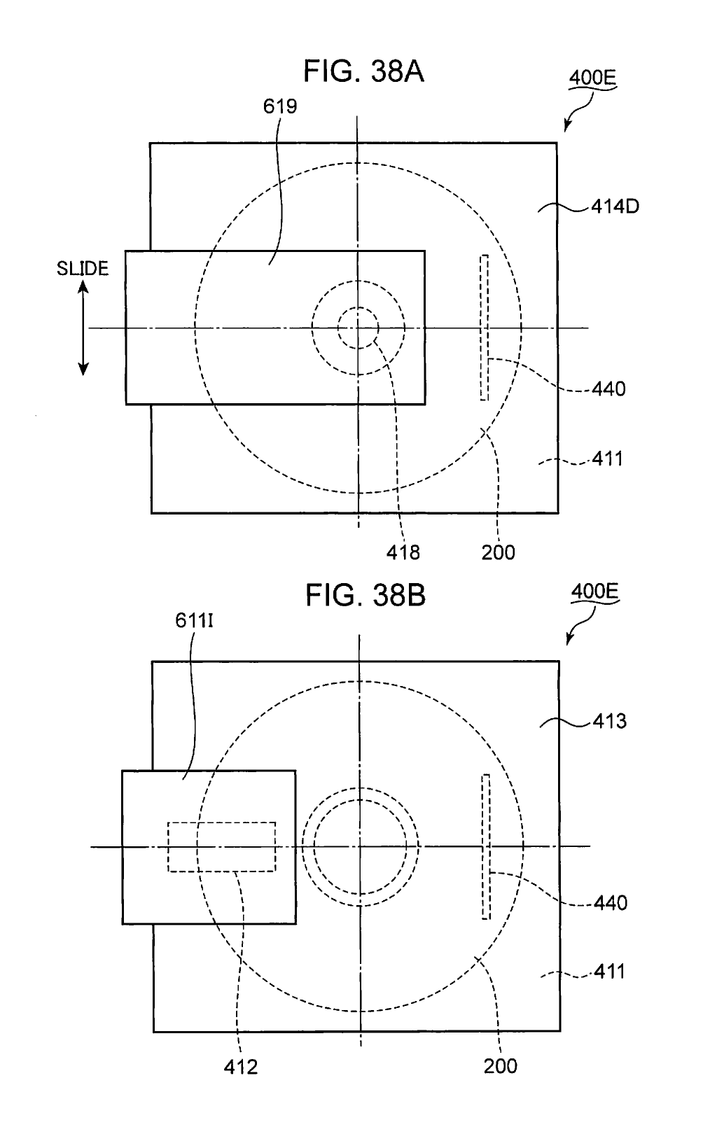

FIG. 38A is a schematic plan view of the cartridge 400E. FIG. 38B is a schematic bottom view of the cartridge 400E. Slide operation of the upper and lower shutter plates 619, 611I on the cartridge 400E is described with reference to FIGS. 37 to 38B.

The upper shutter plate 619 shown in FIG. 38A is situated at the close position. The lower shutter plate 611I shown in FIG. 38B is also situated at the close position. If the upper shutter plate 619 is situated at the close position, the lower shutter plate 611I is also situated the close position. If the upper shutter plate 619 is situated at the open position, the lower shutter plate 611I is also situated at the open position.

The upper shutter plate 619 situated at the close position closes the inlet 418 formed in the upper wall 414D of the cartridge 400E. The upper shutter 619 situated at the open position opens the inlet 418.

The lower shutter plate 611I situated at the close position closes the opening 412 formed in the lower wall 413 of the cartridge 400E. The lower shutter plate 611I situated at the open position opens the opening 412.

While both of the upper and lower shutter plates 619, 611I are situated at the close position, a pathway of dust entering the storage room 411 is dramatically decreased. Meanwhile, if the optical disk 200 is rotated for several seconds to several ten seconds, most of dust in the storage room 411 is collected by the filter 440. Since dust floating in the storage room 411 dramatically decreases, the optical drive system 300I may become very reliable.

The cartridge 400E may have a seal member (not shown) which is situated between the upper shutter plate 619 situated at the close position and the upper wall 414D. If the seal member (e.g. silicon rubber) surrounds the periphery of the inlet 418, dust entering through the inlet 418 may be dramatically decreased during rotation of the optical disk 200.

The cartridge 400E may have a seal member (not shown) which is situated between the lower shutter plate 611I situated at the close position and the lower wall 413. If the seal member (e.g. silicon rubber) surrounds the periphery of the opening 412, dust entering through the opening 412 may be dramatically decreased during rotation of the optical disk 200.

In this embodiment, the upper and lower shutter plates 619, 611I are integrated. Alternatively, the upper and lower shutter plates may be separate members.

The aforementioned various shutter mechanisms may be mounted on the cartridge. Alternatively the shutter mechanism may be mounted on the drive device.

### ELEVENTH EMBODIMENT

The principles of the aforementioned various dust removal techniques are related to near-field light emitted from the SIL. However, the principles of the aforementioned various dust removal techniques may be applied to an optical drive system using other optical elements than the SIL.

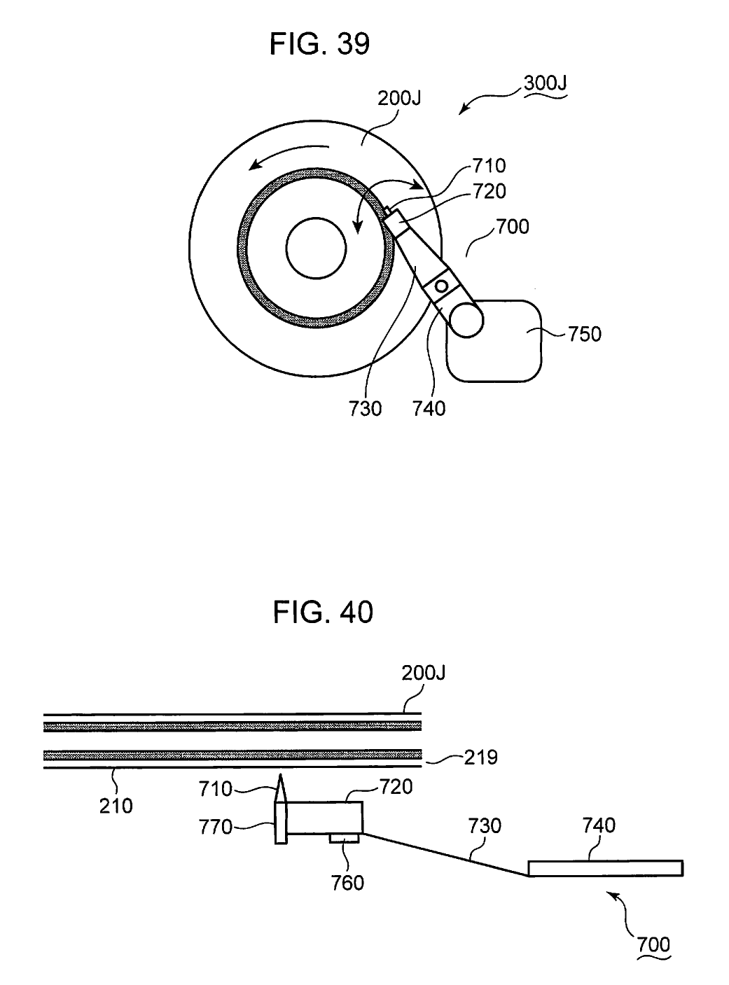

FIG. 39 is a schematic view of an exemplary optical drive system 300J using plasmon resonance.

The optical drive system 300J has a plasmon apparatus 700 configured to perform optical information processes (recording or reproducing signals) on an optical disk 200J. The plasmon apparatus 700 plays functions in correspondence to the optical head and the traverse apparatus according to the first to tenth embodiments.

The plasmon apparatus 700 includes a plasmon head 710, which records and/or reproduces signals to/from the optical disk 200J, and a slider 720 which holds the plasmon head 710. The slider 720 is moved away from the optical disk 200J by air flow resulting from rotation of the optical disk 200J. The mechanism to rotate the optical disk 200J is the same as the driving mechanism described in the context of the first to tenth embodiments.

The plasmon apparatus 700 further includes a suspension 730, which holds the slider 720 by means of a soft plate spring structure (generally called a “gimbal”), a holding member 740, which holds the suspension 730, and a voice coil motor 750, which rotates the holding member 740 in a plane of the optical disk 200J. The voice coil motor 750 may have various components such as a rotary shaft, a coil, a magnet and a yoke.

The optical drive system 300J includes an FPC (not shown), which supplies record signals to the plasmon head 710 or transmits reproduction signals from the plasmon head 710, a head amplifier (not shown), which amplifies signals from the plasmon head 710, and a circuit board, mechanical and electronic components for controlling or operating these elements. The plasmon apparatus 700 may includes a similar structure to known apparatuses for processing information by means of plasmon resonance. Therefore, the principle of this embodiment is not limited to the detailed structure shown here.

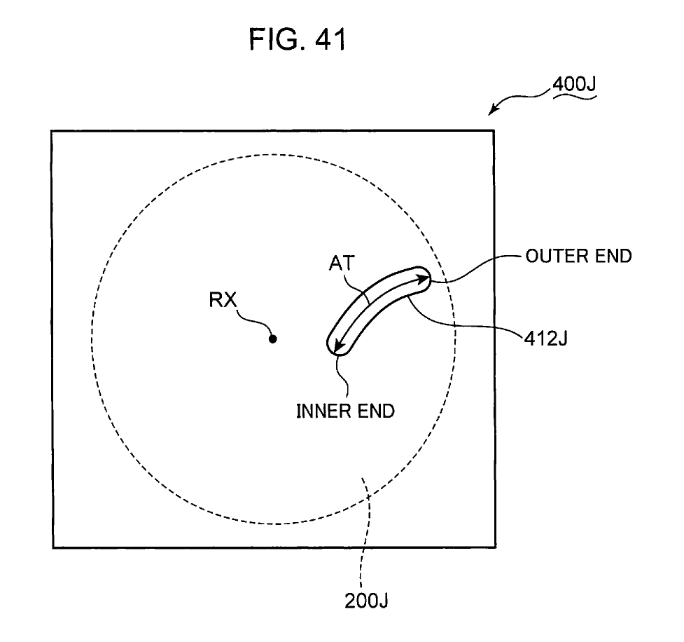

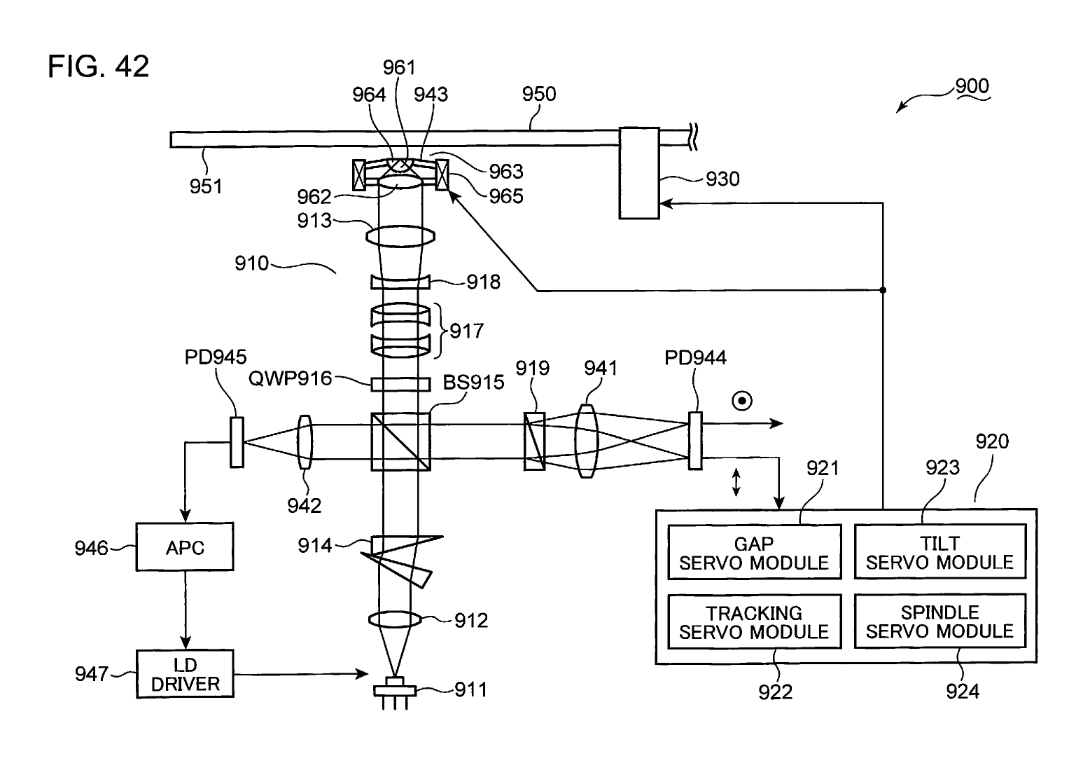

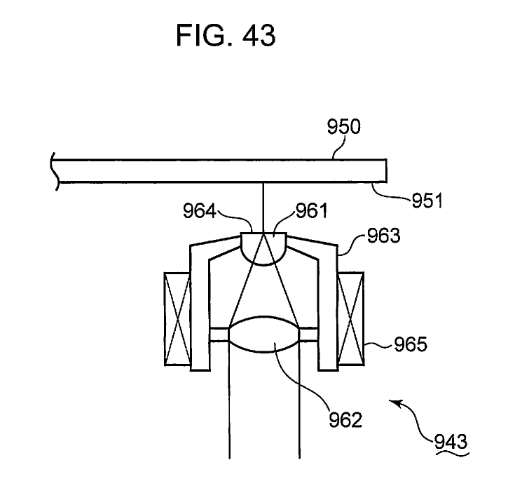

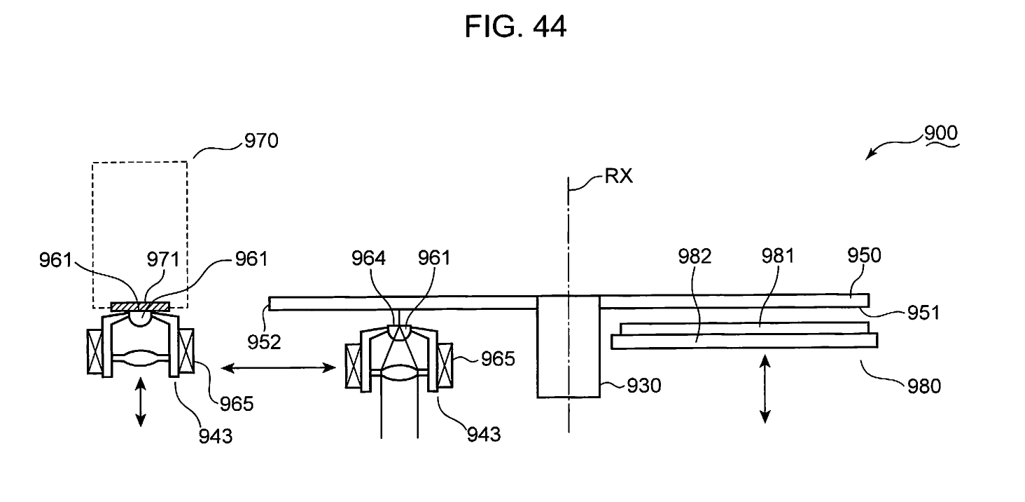

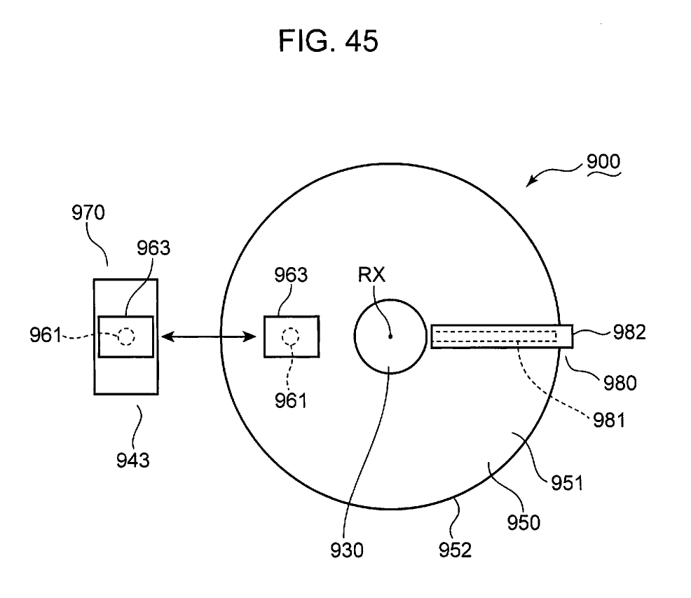

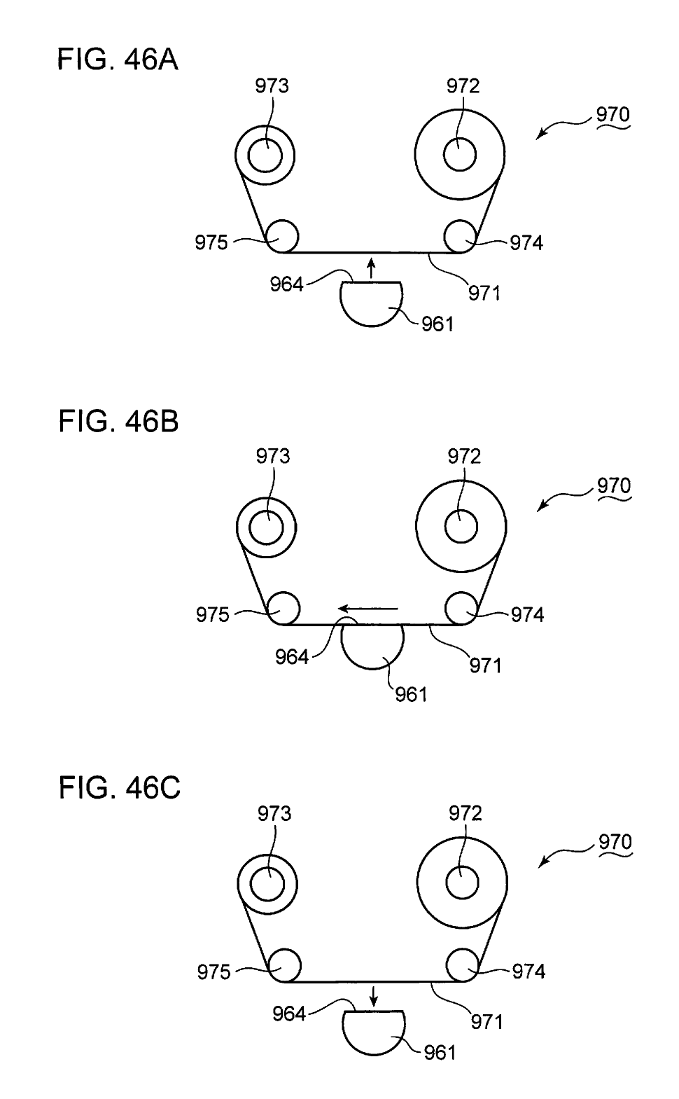

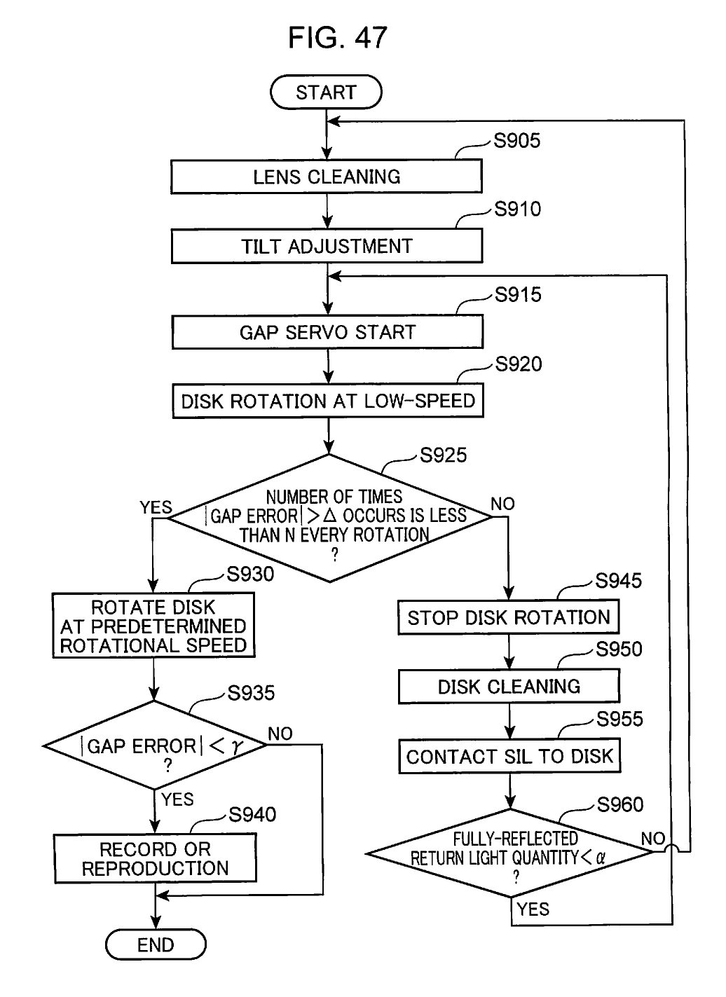

FIG. 40 is a schematic view of the plasmon apparatus 700 configured to perform optical information processes on the optical disk 200J. The plasmon apparatus 700 is further described with reference to FIGS. 39 and 40.

The plasmon apparatus 700 further includes a semiconductor laser 760 and a wave guide 770 which are installed in the slider 720. A laser beam emitted from the semiconductor laser 760 is guided to the plasmon head 710 via the wave guide 770.

The optical disk 200J includes a recording film 219 constituting the record surface 210 which faces the plasmon head 710. In this embodiment, the recording film 219 includes phase change materials.

If the semiconductor laser 760 emits a laser beam to the plasmon head 710, plasmon resonance occurs between the plasmon head 710 and the recording film 219. Consequently, a temperature rises locally on the recording film 219. As a result of the local temperature rise on the recording film 219, crystal structures of the recording film 219 change between crystal and amorphous. A magnitude of resonance between the plasmon head 710 and the recording film 219 depends on the crystal structures (crystal or amorphous) of the recording film 219. With the change in the crystal structures of the recording film 219, information is recorded and/or reproduced in response to the magnitude of the resonance between the plasmon head 710 and the recording film 219.

The optical drive system 300J may include a detector (not shown) which detects reproduction signals on the basis of the resonance magnitude. Reflected or transmitted light of the laser beam emitted from the plasmon head 710 changes in response to a state of the plasmon resonance between the plasmon head 710 and the recording film 219. The detector may reproduce information in response to the change of the reflected or transmitted light. In this embodiment, the plasmon head 710 is exemplified as the optical element.

FIG. 41 is a schematic view of a cartridge 400J integrated into the optical drive system 300J. The cartridge 400J is described with reference to FIGS. 39 and 41.

The plasmon head 710 draws an arch track AT, unlike the SIL in the first to tenth embodiments. An arch opening 412J is formed along the arch track AT in the cartridge 400J. If the optical disk 200J is rotated when the plasmon head 710 is situated near the outer end of the opening 412J (most distant edge from the rotational axis RX of the optical disk 200J), dust adhering to the plasmon head 710 is effectively removed by the swirling flow caused in the cartridge 400J. If the opening 412J is formed so that an opening size at the upstream side of the arch track AT is larger than an opening size at the downstream side, dust is more effectively removed.

The outlet may be formed in a position more distant from the rotational axis RX than the opening 412J. The outlet may be used exclusively for removing dust adhering to the plasmon head 710.

Various features (e.g. filter structure and shutter structure) described in the context of the first to tenth embodiments are suitably applied to the optical drive system 300J of this embodiment.

The aforementioned embodiments are merely examples of the optical drive system. Therefore, the above description is not intended to limit the scope of the principle of the embodiments. It is obvious that various modifications and combinations can be made by those skilled in the art without departing from the true spirit and scope of the aforementioned principle.

The exemplary optical drive systems described in the context of the aforementioned various embodiments mainly have the following features.

An optical drive system according to one aspect of the aforementioned embodiments includes: a cartridge including a wall portion configured to define a storage room to store a rotatable record medium including a light receiving surface which is scanned by light for optically processing information; and a drive device including a rotary driver configured to rotate the record medium in the storage room, an optical element configured to irradiate the light onto the light receiving surface, and a movement driver configured to move the optical element between an inner position where the optical element faces the light receiving surface, and an outer position more distant from a rotational axis of the record medium than the inner position. The wall portion is provided with an outlet at the outer position. Air in the storage room is exhausted from the outlet by air flow resulting from rotation of the record medium. The outlet is divided into a first opening region and a second opening region by a movement track of the optical element so that the first opening region has a first size and the second opening region has a second size larger than the first size. The second opening region is situated at an upstream position of the first opening region in a rotational direction of the record medium.

According to the aforementioned configuration, the wall portion of the cartridge defines a storage room to store a record medium. The rotary driver of the drive device rotates the record medium in the storage room. The optical element of the drive device irradiates the light onto the light receiving surface of the record medium. The movement driver of the drive device moves the optical element between an inner position and an outer position more distant from the rotational axis of the record medium than the inner position. Consequently, the light from the optical element scans the light receiving surface. In the inner position, the optical element faces the light receiving surface so that light is irradiated from the optical element onto the light receiving surface. Accordingly, information is optically processed.

Air flow resulting from rotation of the record medium causes positive pressure at the outer position. The wall portion is provided with an outlet at the outer position. Therefore, the air in the storage room is exhausted from the outlet. Consequently, dust is less likely to stagnate in the storage room.

The outlet is divided into the first and second opening regions by a movement track of the optical element so that the first opening region has a first size and the second opening region has a second size larger than the first size. The second opening region is situated at an upstream position of the first opening region in the rotational direction of the record medium. Therefore, the air exhausted from the outlet is strongly blown onto the optical element which is moved to the outer position by the movement driver. Accordingly, dust adhering to the optical element is removed without contact. Consequently, the optical drive system becomes very reliable.

In the aforementioned configuration, the outlet may be an opening which extends from the outer position to the inner position. The movement driver may move the optical element along the opening, so that the information is optically processed.

According to the aforementioned configuration, the movement driver may move the optical element along the opening which extends from the outer position to the inner position. During the movement of the optical element, the light from the optical element may scan the light receiving surface to optically process information.

The air flow resulting from the rotation of the record medium causes positive pressure at the outer position, so that the air in the storage room is exhausted from the opening around the outer position. Therefore, the opening functions as an outlet around the outer position. The optical element which is moved to the outer position by the movement driver is strongly blown by the air exhausted from the opening. Accordingly, the dust adhering to the optical element is removed without contact. Consequently, the optical drive system becomes very reliable.

In the aforementioned configuration, the wall portion may be provided with an opening extending from the inner position. The movement driver may move the optical element along the opening to scan the light receiving surface. The outlet may be formed in a position more distant from the rotational axis than the opening.

According to the aforementioned configuration, the movement driver may move the optical element along the opening extending from the inner position. During the movement of the optical element, the light from the optical element may scan the light receiving surface to optically process information.

The outlet is formed in a position more distant from the rotational axis than the opening. Therefore, the optical element, which is moved to the outer position by the movement driver, is strongly blown by the air exhausted from the opening. Accordingly, dust adhering to the optical element is removed without contact. Consequently, the optical drive system becomes very reliable.

In the aforementioned configuration, the wall portion may include a first wall, in which the outlet is formed, and a second wall which faces the first wall. The second wall is provided with an inlet through which air flows into the storage room. The inlet may be closer to the inner position than the outer position.

According to the aforementioned configuration, the second wall facing the first wall, in which the outlet is formed, is provided with the inlet which is closer to the inner position than the outer position. Since the air flow resulting from the rotation of the record medium causes a negative pressure at the inner position, air flows into the storage room through the inlet to increase a flow rate of the air flowing from the inlet to the outlet. Accordingly, the optical element, which is moved to the outer position by the movement driver, is strongly blown by the air exhausted from the outlet. Consequently, dust adhering to the optical element is removed without contact. Therefore, the optical drive system becomes very reliable.

In the aforementioned configuration, the optical drive system may further include a shutter mechanism having a first shutter configured to move between a close position to at least partially close the opening and an open position to open the opening.

According to the aforementioned configuration, the first shutter moves between the close and open positions to make a size of the opening variable. Therefore, a flow rate of the air hitting the optical element, which is moved to the outer position by the movement driver, may be appropriately adjusted by the first shutter.

In the aforementioned configuration, the first shutter may close the outlet at the close position.

According to the aforementioned configuration, the first shutter closes the outlet at the close position. Therefore, less dust enters the storage room through the outlet.

In the aforementioned configuration, the optical drive system may further include a shutter mechanism having a first shutter configured to move between a close position to close the opening and an open position to open the opening, and a second shutter configured to move in conjunction with the first shutter. The second shutter may close the inlet when the first shutter is in the close position.

According to the aforementioned configuration, the first shutter closes the outlet at the close position. Therefore, less dust enters the storage room through the outlet. When the first shutter is situated at the close position, the second shutter closes the inlet. Accordingly, less dust enters the storage room through the inlet.

In the aforementioned configuration, the cartridge may include a filter configured to collect dust in the storage room.

According to the aforementioned configuration, the filter collects dust in the storage room. Therefore, less dust floats in the storage room. Consequently, the optical drive system becomes very reliable.

In the aforementioned configuration, the cartridge may have a filter situated in the inlet. The filter collects dust from air flowing into the storage room.

According to the aforementioned configuration, the filter situated in the inlet collects dust from air flowing into the storage room. Therefore, less dust flows into the storage room. Consequently, the optical drive system becomes very reliable.

In the aforementioned configuration, the cartridge may include a filter configured to collect dust in the storage room. The rotary driver may rotate the record medium while the first shutter is in the close position.

According to the aforementioned configuration, the rotary driver rotates the record medium while the first shutter is in the close position to cause air flow in the storage room. Therefore, the filter may efficiently collect dust in the storage room. Consequently, the optical drive system becomes very reliable.

In the aforementioned configuration, the optical element may scan the light receiving surface by means of the light to perform at least one optical information process of recording information to the record medium and reproducing information stored in the record medium.

According to the aforementioned configuration, the optical element scans the light receiving surface by means of the light to perform at least one optical information process of recording information to the record medium and reproducing information stored in the record medium. Since the optical drive system is very reliable, the optical information process is appropriately executed.

In the aforementioned configuration, the optical element may condense the light onto the light receiving surface to generate near-field light.

According to the aforementioned configuration, the optical element condenses the light onto the light receiving surface to generate near-field light. Accordingly, information is processed by the near-field light.

In the aforementioned configuration, the drive device may include a holder configured to hold the optical element, and an actuator configured to drive the holder in a focusing direction and a tracking direction of the record medium with elastically supporting the holder.

According to the aforementioned configuration, the actuator elastically supports the holder which holds the optical element. Since the actuator drives the holder in the focusing and tracking directions of the record medium, the light receiving surface is appropriately scanned.

The exemplary cartridges described in the context of the aforementioned various embodiments mainly have the following features.

A cartridge according to one aspect of the aforementioned embodiments defines a storage room to store a rotatable record medium including a light receiving surface which is scanned by light for optically processing information. The cartridge includes a wall portion provided with an outlet, from which air in the cartridge is exhausted by air flow resulting from rotation of the record medium in a position apart from a rotational axis of the record medium. The outlet is divided into a first opening region and a second opening region by a scanning track of the light so that the first opening region has a first size and the second opening region has a second size larger than the first size. The second opening region is situated at an upstream position of the first opening region in a rotational direction of the record medium.

According to the aforementioned configuration, the wall portion of the cartridge defines a storage room to store a record medium. The air flow resulting from the rotation of the record medium causes positive pressure at the outer position. The wall portion is provided with the outlet at the outer position, so that the air in the storage room is exhausted from the outlet. Consequently, dust is less likely to stagnate in the storage room.

The outlet is divided into the first and second opening regions by the scanning track of the light so that the first opening region has a first size and the second opening region has a second size larger than the first size. The second opening region is situated in an upstream position of the first opening region in the rotational direction of the record medium. Therefore, dust interfering light is appropriately removed at the outer position.

The exemplary drive device described in the context of the aforementioned various embodiments mainly have the following features.

A drive devices according to one aspect of the aforementioned embodiments includes: a rotary driver configured to rotate a record medium including a light receiving surface which is scanned by light for optically processing information; an optical element configured to irradiate the light onto the light receiving surface; a movement driver configured to move the optical element between an inner position, in which the optical element faces the light receiving surface, and an outer position more distant from the rotational axis of the record medium than the inner position; a holder configured to hold the optical element; and an actuator configured to drive the holder in the focusing and tracking directions of the record medium with elastically supporting the holder. The actuator makes the optical element approach a plane, which extends along the light receiving surface, at the outer position.

According to the aforementioned configuration, the rotary driver of the drive device rotates a record medium in the storage space. The optical element of the drive device irradiates light onto the light receiving surface of the record medium. The movement driver of the drive device moves the optical element between the inner position and the outer position more distant from the rotational axis of the record medium than the inner position. Consequently, the light from the optical element scans the light receiving surface. The optical element faces the light receiving surface at the inner position. Therefore, the light is irradiated from the optical element onto the light receiving surface. Accordingly, information is optically processed.

The air flow resulting from the rotation of the record medium causes positive pressure at the outer position. The actuator makes the optical element approach the plane, which extends along the light receiving surface, at the outer position. Accordingly, the optical element, which is moved to the outer position by the movement driver, is strongly blown by the air exhausted from the outlet. Therefore, dust adhering to the optical element is removed without contact. Consequently, the optical drive system becomes very reliable.

The exemplary methods for cleaning the optical drive system described in the context of the aforementioned various embodiments mainly have the following features.

A method for cleaning the optical drive system according to one aspect of the aforementioned embodiments includes steps of: rotating the record medium; moving the optical element from the inner position to the outer position; and making the optical element approach a plane, which extends along the light receiving surface, so as to expose the optical element to air flow resulting from rotation of the record medium.

According to the aforementioned configuration, the air flow resulting from the rotation of the record medium causes positive pressure at the outer position. The optical element, which is moved to the outer position, approaches the plane which extends along the light receiving element, and is strongly exposed to the air flow. Therefore, dust adhering to the optical element is removed without contact. Consequently, the optical drive system becomes very reliable.

A method for cleaning the optical drive system according to another aspect of the aforementioned embodiments includes steps of: moving the first shutter to the close position; and rotating the record medium.

According to the aforementioned configuration, the first shutter is moved to the close position. Therefore, less dust enters the storage room. The filter may efficiently collect the dust in the storage room by means of the air flow resulting from the rotation of the record medium.

### INDUSTRIAL APPLICABILITY

On the basis of the principle of the aforementioned various embodiments, dust floating in the storage room to store a record medium and adhering to the optical element configured to emit light onto the record medium may be appropriately removed. Therefore, the principle of the aforementioned embodiments is particularly effective for an apparatus which requires a narrow gap between a record medium and a lens (e.g. SIL). Since appropriate dust removal prevents dust from being caught in the narrow gap, the apparatus utilizing the principle of the aforementioned embodiments (e.g. external storage apparatus of a computer, an image recording apparatus to record image data, an image reproducing apparatus to reproduce image data) may handle large capacity data. The principle of the aforementioned embodiments may be applied to various apparatuses with functions to record and/or reproduce data (e.g. car navigation system, portable music player, digital still camera and digital video camera).

1. An optical drive system, comprising:
a cartridge including a wall portion configured to define a storage room to store a rotatable record medium including a light receiving surface which is scanned by light for optically processing information; and
a drive device including a rotary driver configured to rotate the record medium in the storage room, an optical element configured to irradiate the light onto the light receiving surface, and a movement driver configured to move the optical element between an inner position where the optical element faces the light receiving surface, and an outer position more distant from a rotational axis of the record medium than the inner position, wherein
the wall portion is provided with an outlet at the outer position, air in the storage room being exhausted from the outlet by air flow resulting from rotation of the record medium,
the outlet is divided into a first opening region and a second opening region by a movement track of the optical element so that the first opening region has a first size and the second opening region has a second size larger than the first size, and
the second opening region is situated at an upstream position of the first opening region in a rotational direction of the record medium.

2. The optical drive system according to claim 1, wherein
the outlet is an opening which extends from the outer position to the inner position, and
the movement driver moves the optical element along the opening so that the information is optically processed.

3. The optical drive system according to claim 1, wherein
the wall portion is provided with an opening which extends from the inner position,
the movement driver moves the optical element along the opening to scan the light receiving surface, and
the outlet is formed in a position more distant from the rotational axis than the opening.

4. The optical drive system according to claim 1, wherein
the wall portion includes a first wall, in which the outlet is formed, and a second wall which faces the first wall,
the second wall is provide with an inlet through which air flows into the storage room, and
the inlet is closer to the inner position than the outer position.

5. The optical drive system according to claim 2, further comprising:
a shutter mechanism having a first shutter configured to move between a close position to at least partially close the opening and an open position to open the opening.

6. The optical drive system according to claim 5, wherein
the first shutter closes the outlet at the close position.

7. The optical drive system according to claim 4, further comprising a shutter mechanism including a first shutter configured to move between a close position to close the opening and an open position to open the opening, and a second shutter configured to move in conjunction with the first shutter, wherein
the second shutter closes the inlet when the first shutter is in the close position.

8. The optical drive system according to claim 1, wherein
the cartridge includes a filter configured to collect dust in the storage room.

9. The optical drive system according to claim 4, wherein
the cartridge includes a filter situated in the inlet, and
the filter collects dust from the air flowing into the storage room.

10. The optical drive system according to claim 6, wherein
the cartridge includes a filter configured to collect dust in the storage room, and
the rotary driver rotates the record medium while the first shutter is in the close position.

11. The optical drive system according to claim 1, wherein
the optical element scans the light receiving surface by means of the light to perform at least one optical information process of recording information to the record medium and reproducing information stored in the record medium.

12. The optical drive system according to claim 1, wherein
the optical element condenses the light onto the light receiving surface to generate near-field light.

13. The optical drive system according to claim 1, wherein
the drive device includes a holder configured to hold the optical element, and an actuator configured to drive the holder in a focusing direction and a tracking direction of the record medium with elastically supporting the holder.

14. A cartridge for defining a storage room to store a rotatable record medium including a light receiving surface which is scanned by light for optically processing information, comprising:
a wall portion provided with an outlet apart from a rotational axis of the record medium, so that air in the cartridge is exhausted from the outlet by air flow resulting from rotation of the record medium, wherein
the outlet is divided into a first opening region and a second opening region by a scanning track of the light so that the first opening region has a first size and the second opening region has a second size larger than the first size, and
the second opening region is situated at an upstream position of the first opening region in a rotational direction of the record medium.

15. A drive device, comprising:
a rotary driver configured to rotate a record medium including a light receiving surface which is scanned by light for optically processing information;
an optical element configured to irradiate the light onto the light receiving surface;
a movement driver configured to move the optical element between an inner position where the optical element faces the light receiving surface and an outer position more distant from a rotational axis of the record medium than the inner position;
a holder configured to hold the optical element; and
an actuator configured to drive the holder in a focusing direction and a tracking direction of the record medium with elastically supporting the holder, wherein
the actuator makes the optical element approach a plane, which extends along the light receiving surface, at the outer position.

16. A method for cleaning the optical drive system according to claim 1, comprising steps of:
rotating the record medium;
moving the optical element from the inner position to the outer position; and
making the optical element approach a plane which extends along the light receiving surface, so as to expose the optical element to air flow resulting from rotation of the record medium.

17. A method for cleaning the optical drive system according to claim 10, comprising steps of:
moving the first shutter to the close position; and
rotating the record medium.
